(19) United States
(12) Patent Application Publication
(10) Pub. No.: US 2026/0032495 A1
(43) Pub. Date: Jan. 29, 2026

(54) CALIBRATION AND CSI REPORTING

(71) Applicant: Samsung Electronics Co., Ltd., Suwon-si (KR)

(72) Inventors: Gilwon Lee, Prosper, TX (US); Md. Saifur Rahman, Plano, TX (US); Eko Onggosanusi, Coppell, TX (US)

(21) Appl. No.: 19/258,799

(22) Filed: Jul. 2, 2025

Related U.S. Application Data
(60) Provisional application No. 63/676,760, filed on Jul. 29, 2024.
(60) Provisional application No. 63/678,949, filed on Aug. 2, 2024.
(60) Provisional application No. 63/679,378, filed on Aug. 5, 2024.
(60) Provisional application No. 63/705,361, filed on Oct. 9, 2024.

(51) Int. Cl. H04W 24/10; H04L 5/00

(52) U.S. Cl. CPC H04W 24/10; H04L 5/0051

(57) ABSTRACT

Apparatuses and methods for calibration and channel state information (CSI) reporting. A method performed by a user equipment (UE) includes receiving information about first and second CSI reports. The information indicates for the first CSI report, N_{TRP} CSI reference signal (CSI-RS) resource sets and a report quantity, which corresponds to delay offset (DO) reporting and, for the second CSI report, N_{TRP} CSI-RS resources and a codebook type. The method further includes determining, based on the information, DO values for the first CSI report and determining, based on the information and the DO values, a CSI for the second CSI report. The CSI is determined by compensating for the DO values. The method further includes transmitting the first and second CSI reports in a same reporting instance, the first and second CSI reports include the DO values and the CSI, respectively.

### CROSS-REFERENCE TO RELATED AND CLAIM OF PRIORITY

The present application claims priority under 35 U.S.C. § 119 (e) to U.S. Provisional Patent Application No. 63/676,760 filed on Jul. 29, 2024; U.S. Provisional Patent Application No. 63/678,949 filed on Aug. 2, 2024; U.S. Provisional Patent Application No. 63/679,378 filed on Aug. 5, 2024; and U.S. Provisional Patent Application No. 63/705,361 filed on Oct. 9, 2024, which are hereby incorporated by reference in their entirety.

### TECHNICAL FIELD

The present disclosure relates generally to wireless communication systems and, more specifically, the present disclosure is related to apparatuses and methods for calibration and channel state information (CSI) reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to calibration and CSI reporting.

In one embodiment, a UE is provided. The UE includes a transceiver configured to receive information about first and second channel state information (CSI) reports. The information indicates for the first CSI report, N_{TRP} CSI reference signal (CSI-RS) resource sets, N_{TRP}>1 and a report quantity, which corresponds to delay offset (DO) reporting and, for the second CSI report, N_{TRP} CSI-RS resources and a codebook type. The codebook type is set to ‘typeII-CJT-r18’. The first and second CSI reports are configured to be linked via a higher-layer parameter. The UE further includes a processor operably coupled to the transceiver. The processor is configured to determine, based on the information, DO values for the first CSI report and determine, based on the information and the DO values, a CSI for the second CSI report. The CSI is determined by compensating for the DO values. The transceiver is further configured to transmit the first and second CSI reports in a same reporting instance, the first and second CSI reports include the DO values and the CSI, respectively.

In another embodiment, a base station (BS) is provided. The BS includes a processor and a transceiver operably coupled to the processor. The transceiver is configured to transmit, to a UE, information about first and second CSI reports. The information indicates for the first CSI report, N_{TRP} CSI-RS resource sets, N_{TRP}>1 and a report quantity, which corresponds to DO reporting and, for the second CSI report, N_{TRP} CSI-RS resources and a codebook type. The codebook type is set to ‘typeII-CJT-r18’. The first and second CSI reports are configured to be linked via a higher-layer parameter. The transceiver is further configured to receive, from the UE, the first and second CSI reports in a same reporting instance. The first and second CSI reports include DO values and a CSI, respectively. The DO values for the first CSI report are based on the information. The CSI for the second CSI report are based on the information and the DO values. The CSI compensates for the DO values.

In yet another embodiment, the method includes receiving information about first and second CSI reports. The information indicates for the first CSI report, N_{TRP} CSI-RS resource sets, N_{TRP}>1 and a report quantity, which corresponds to DO reporting and, for the second CSI report, N_{TRP} CSI-RS resources and a codebook type. The codebook type is set to ‘typeII-CJT-r18’. The first and second CSI reports are configured to be linked via a higher-layer parameter. The method further includes determining, based on the information, DO values for the first CSI report and determining, based on the information and the DO values, a CSI for the second CSI report. The CSI is determined by compensating for the DO values. The method further includes transmitting the first and second CSI reports in a same reporting instance, the first and second CSI reports include the DO values and the CSI, respectively.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a diagram of an antenna port layout according to embodiments of the present disclosure;

FIG. 11 illustrates examples of a UE moving on a trajectory with antenna groups (AGs) of the BS co-located and distributed according to embodiments of the present disclosure; and

FIG. 12 illustrates an example method performed by a UE in a wireless communication system according to embodiments of the present disclosure.

### DETAILED DESCRIPTION

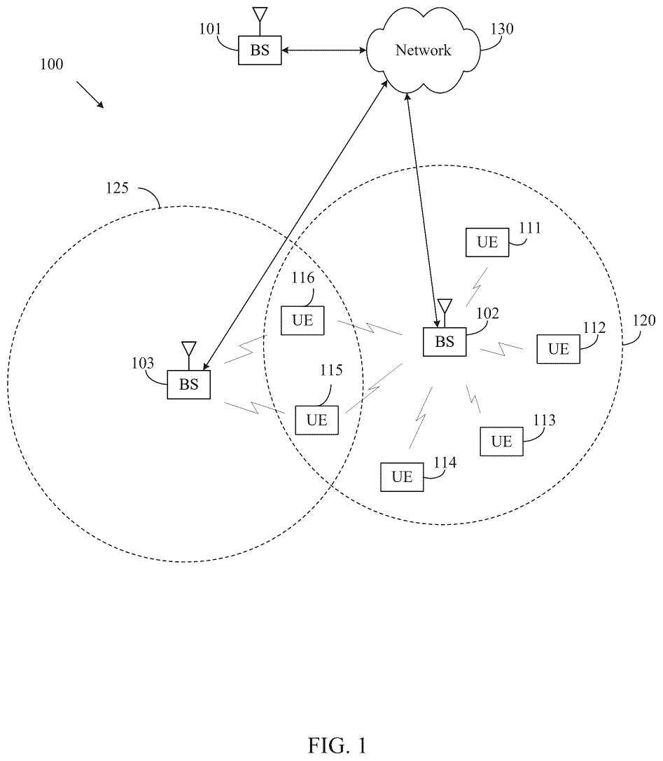

FIGS. 1-12 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 36.211 v18.0.1, “E-UTRA, Physical channels and modulation;” [REF 2] 3GPP TS 36.212 v18.0.0, “E-UTRA, Multiplexing and Channel coding;” [REF 3] 3GPP TS 36.213 v18.2.0, “E-UTRA, Physical Layer Procedures;” [REF 4] 3GPP TS 36.321 v18.2.0, “E-UTRA, Medium Access Control (MAC) protocol specification;” [REF 5] 3GPP TS 36.331 v18.2.0, “E-UTRA, Radio Resource Control (RRC) Protocol Specification;” [REF 6] 3GPP TR 22.891 v1.2.0; [REF 7] 3GPP TS 38.212 v18.2.0, “E-UTRA, NR, Multiplexing and Channel coding;” [REF 8] 3GPP TS 38.214 v18.2.0, “E-UTRA, NR, Physical layer procedures for data;” and [REF 9] 3GPP TS 38.211 v18.2.0, “E-UTRA, NR, Physical channels and modulation.”

FIGS. 1-11 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing calibration and CSI reporting. In certain embodiments, one or more of the BSs 101-103 include circuitry, programing, or a combination thereof to support calibration and CSI reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

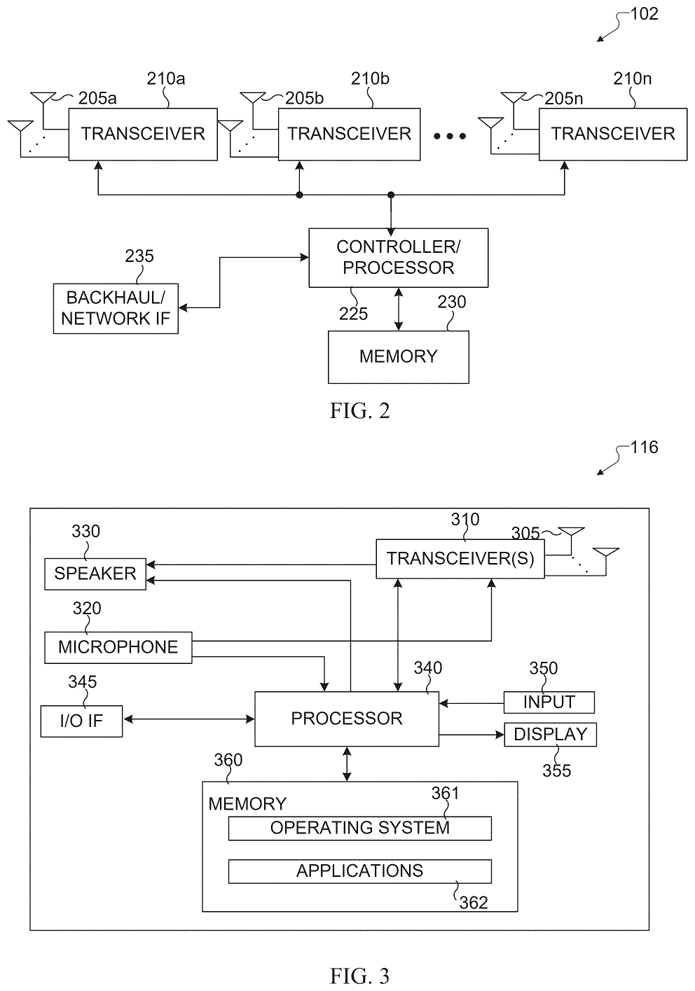

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for calibration and CSI reporting. Any of a wide variety of other functions could be supported in the gNB 102 by the controller/processor 225.

The controller/processor 225 is also capable of executing programs and other processes resident in the memory 230, such as processes to support calibration and CSI reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for calibration and CSI reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

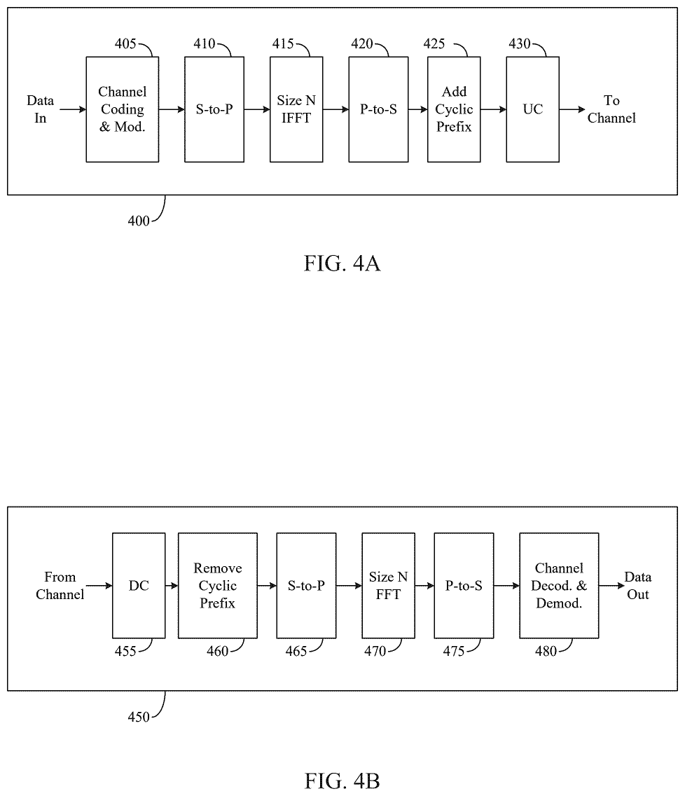

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for calibration and CSI reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

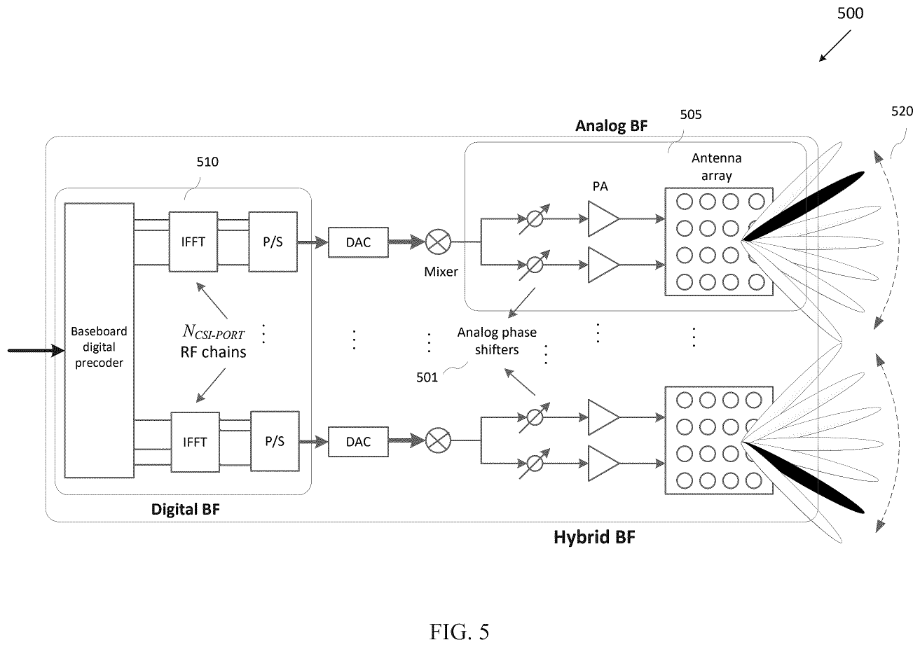

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

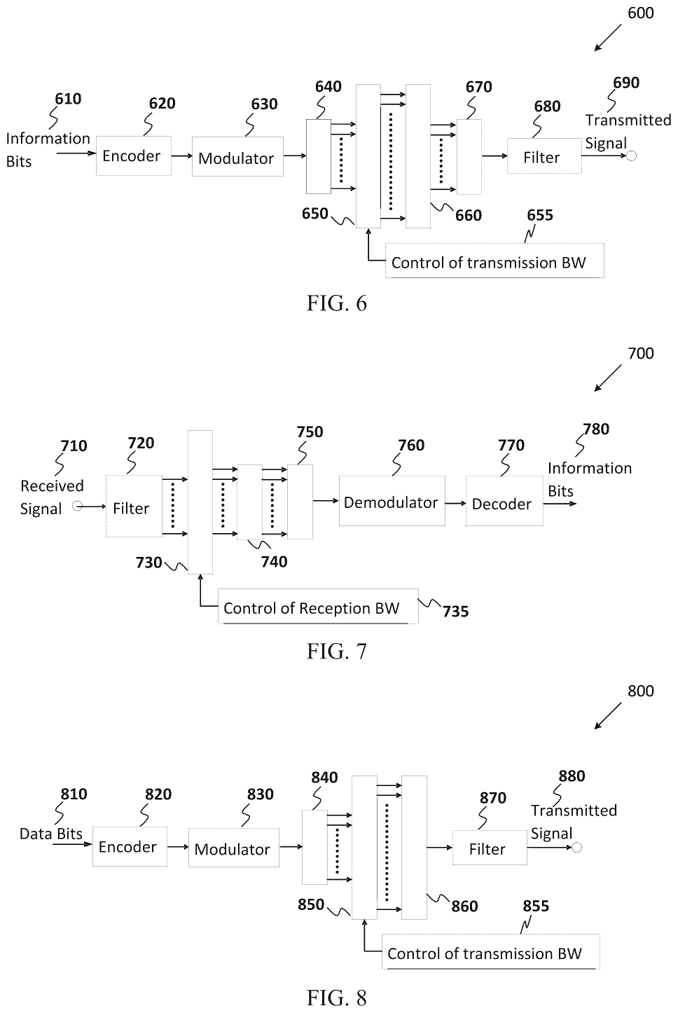

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

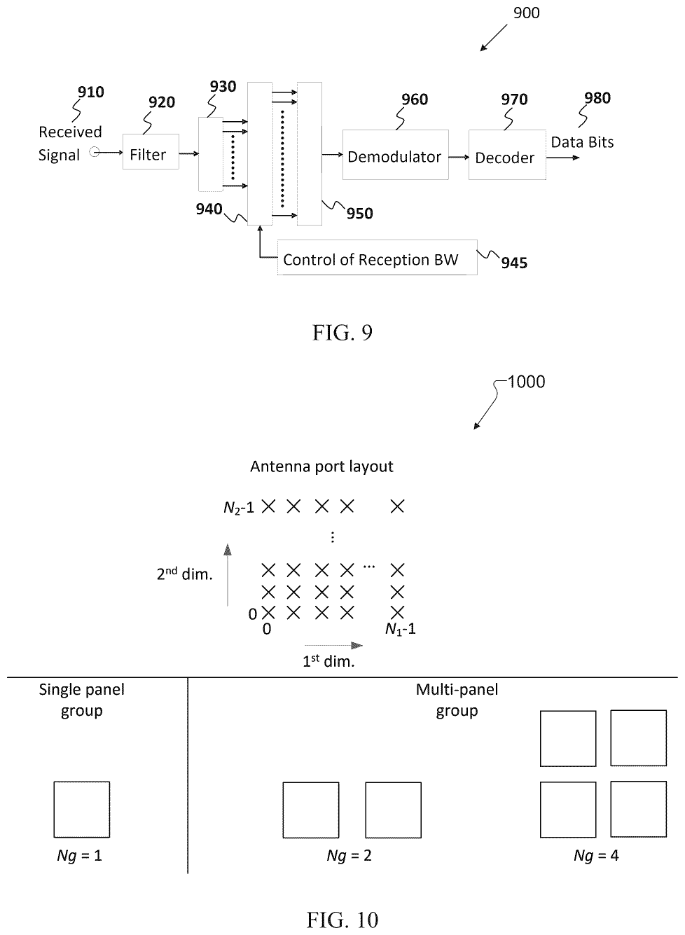

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown herein.

TABLE 0

| Frequency range designation | Corresponding frequency range |
|---|---|
| FR1 | 450 MHz-600 MHz |
| FR2 | 24250 MHz-52600 MHz |

The present disclosure relates generally to wireless communication systems and, more specifically, to antenna calibration and CSI reporting.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB (eNB) or gNodeB (gNB), which is generally a fixed station, may also be referred to as an access point or other equivalent terminology. For LTE systems, a NodeB is often referred as an eNodeB. For NR systems, a NodeB is often referred as an gNodeB.

In a communication system, such as NR or LTE, DL signals can include data signals conveying information content, control signals conveying DL Control Information (DCI), and Reference Signals (RS) that are also known as pilot signals. An eNodeB transmits data information through a Physical DL Shared CHannel (PDSCH). An eNB/gNB (e.g., the BS 102) transmits DCI through a Physical DL Control CHannel (PDCCH). An eNB/gNB transmits one or more of multiple types of RS including a Channel State Information RS (CSI-RS), or a DeModulation RS (DMRS). An eNB/gNB may transmit a CSI-RS for time/frequency tracking (aka CRS in LTE or TRS in NR), for CSI reporting. DMRS can be transmitted only in the BW of a respective PDSCH and a UE can use the DMRS to demodulate data or control information in a PDSCH or a PDCCH, respectively. A transmission time interval for DL channels is referred to as a subframe or slot and can have, for example, duration of 1 millisecond or a value depending on the subcarrier-spacing (SCS).

DL signals also include transmission of a logical channel that carries system control information. A broadcast control channel (BCCH) is mapped to either a transport channel referred to as a Broadcast CHannel (BCH) when it conveys a Master Information Block (MIB) or to a DL Shared CHannel (DL-SCH) when it conveys a System Information Block (SIB)—see also REF3 and REF 5. Most system information is included in different SIBs that are transmitted using DL-SCH. A presence of system information on a DL-SCH in a subframe (or slot) can be indicated by a transmission of a corresponding PDCCH conveying a codeword with a CRC scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW includes frequency resource units referred to as Resource Blocks (RBs). Each RB includes

$${N}_{s c}^{R B}$$

sub-carriers, or Resource Elements (REs), such as 12 REs. A unit of one RB over one subframe (or slot) is referred to as a PRB. A UE can be allocated MPDSCH RBs for a total of

$${M}_{sc}^{P D S C H} = {M}_{P D S C H} \cdot {N}_{sc}^{R B}$$

### REs for the PDSCH Transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNB/gNB can use a DMRS to demodulate data signals or UCI signals. A UE transmits SRS to provide an eNB/gNB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, and Channel State Information (CSI) enabling an eNB/gNB to perform link adaptation for PDSCH transmissions to a UE. HARQ-ACK information is also transmitted by a UE in response to a detection of a PDCCH indicating a release of semi-persistently scheduled PDSCH (see also REF 3).

An UL subframe (or slot) includes two slots. Each slot includes

$${N}_{s y m b}^{UL}$$

symbols for transmitting data information, UCI, DMRS, or SRS. A frequency resource unit of an UL system BW is a RB. A UE is allocated NRB RBs for a total of

$${N}_{R B} \cdot {N}_{s c}^{R B}$$

REs 101 a transmission DW. A last few subframe (or slot) symbols can be used to multiplex SRS transmissions from one or more UEs.

For MIMO in FR1, up to 32 CSI-RS antenna ports in one CSI-RS resource is supported, and in FR2, up to 8 CSI-RS antenna ports in one CSI-RS resource is supported. A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital.

In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is actionable.

In next generation cellular standards (e.g. 6G), in addition to FR1 and FR2, new carrier frequency bands can be evaluated, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs within a cellular region can be the main scenario of interest, due to which the number of CSI-RS antenna ports for MIMO can be even larger (e.g. up to 256).

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed taking into account carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the MU-MIMO spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated.

The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For time division duplexing (TDD) systems, the CSI can be acquired using the SRS transmission relying on the channel reciprocity. For frequency division duplexing (FDD) systems, on the other hand, it can be acquired using the CSI-RS transmission from eNB (or gNB), and CSI acquisition and feedback from UE.

In 5G or NR systems [REF7, REF8], both low-(aka Type I) and high-resolution (aka Type II) CSI reporting mechanisms are supported. In addition, to reduce Type II CSI reporting, a frequency domain (FD) compression based Type II CSI is also supported, which is based on (a) spatial domain (SD) basis W₁, (b) FD basis W_{f}, and (c) coefficients \tilde{W}₂ that linearly combine SD and FD bases. For a (full TDD or partial FDD) reciprocity, CSI-RS ports can be beamformed (using SRS measurements, expecting UL-DL channel reciprocity in angular/delay), and the SD basis corresponds to a port selection basis.

In Rel.18, the FD-compression-based Type II CSI is further enhanced for the use case of CJT across up to 4 TRPs, under the idealistic expectations such as perfectly time and frequency synchronized mTRPs, phase-coherent antenna ports and ideal backhaul links. In practice, however, these expectation are not valid, and calibration/synchronization across TRPs is necessary in order to make CJT feasible.

Massive MIMO base stations or TRPs use an on-board coupling network and calibration circuits, referred to as the on-board calibration for brevity, to measure the gain and phase differences among transceivers in the same radio frequency (RF) unit in order to maintain the reciprocity between DL and UL channels, in the TDD system in particular. For the on-board calibration, one RF chain corresponding to one antenna port serves as a reference to other RF chains for other antenna ports. In the case of the mTRP system, embodiments of the present disclosure recognize that such reference transceiver's signal needs to be shared between distributed RRHs/panels/modules/TRPs, which are physically far apart or non-co-located. Using RF cables to distribute the reference is not preferable as it limits the deployment scenarios. In addition, the use of different local oscillators (LOs) between distributed antenna modules imposes even more challenges in achieving calibration as the phase of LOs could drift. Periodic calibration is needed to compensate for the phase drift as well.

Issue 1: In one example, the timing offset can be expressed as Tₜ=e^{j2πf(t+Δt)}, where Δt is due to timing difference between (distributed, non-co-located) TRPs or/and different propagation delays from different TRPs, which amounts to increased frequency-selectivity of the composite channel. The min freq. granularity (supported in NR) is 2 RBs (for PMI) and 4 RBs (CQI), which correspond to a max delay spread 2.8 and 1.4 micro second for SCS=15 and 30 kHz, respectively. This delay spread decreases further with increasing freq. granularity (due to timing offset). For large delay spread, the required freq. granularity for CJT (across TRPs) will be smaller than 2RBs.

TABLE 9.6.1.3-1
OTA frequency error minimum requirement

| BS class | Accuracy |
|---|---|
| Wide Area BS | ±0.05 ppm |
| Medium Range BS | ±0.1 ppm |
| Local Area BS | ±0.1 ppm |

Issue 2: In one example, the frequency offset can be expressed as T_{f}=e^{j2π(f+Δf)t}, where Δf is due to non-ideal (and potentially different) local oscillators or crystal types at different TRPs, which results in frequency differences between TRPs. As shown herein, the min freq. error=0.05 ppm, according to TS 38.104. The phase change due to freq. error can be significant, especially at higher carrier frequencies.

In general, the combined (time-frequency) T-F offset can be expressed as T_{t,f}=e^{j2π(f+Δf)(t+Δt)}. For CJT feasibility, (Δt, Δf) needs to be calibrated for frequently

Issue 3: non-ideal backhaul links between TRPs, especially when the backhaul links are not fiber-optic cables.

Issue 4: phase-coherency across antenna ports, both intra-TRP (within each TRP) and inter-TRP (across TRPs).

In this disclosure, the mechanism are procedures are provided for Issue 1 and 2, which are more severe than Issue 3 and 4.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

This disclosure provides CSI reporting based on calibration-related information (CLI). The calibration-related information such as delay-offset and/or frequency offset values can be reported via a new feature being developed in Rel-19 CJT calibration reporting on PUSCH. This disclosure provides a framework to report CSI for CJT, where the CSI is computed/determined with expecting pre-compensation (at the UE side) utilizing the calibration-related information.

The 2 aspects as follows:
Joint reporting of CSI and CLI multiplex in a same slot
Configuration, restriction, linkage between CSI and CLI reporting.

Although the focus of this disclosure is on 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

In the following, for brevity, both FDD and TDD are provided as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI or calibration coefficient reporting setting.

“CSI or calibration coefficient reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”.

The term “CSI or calibration coefficient reporting band” is used only as an example for representing a function. Other terms such as “CSI or calibration coefficient reporting subband set” or “CSI or calibration coefficient reporting bandwidth” can also be used.

In terms of UE configuration, a UE (e.g., the UE 116) can be configured with at least one CSI or calibration coefficient reporting band. This configuration can be semi-static (via higher-layer signaling or RRC) or dynamic (via MAC CE or L1 DL control signaling). When configured with multiple (N) CSI or calibration coefficient reporting bands (e.g. via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

FIG. 10 illustrates a diagram of an antenna port layout 1000 according to embodiments of the present disclosure. For example, antenna port layout 1000 of an antenna port layout can be implemented by the BS 102 of FIG. 2. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1 is provided, and for 1D antenna port layouts N₁>1 and N₂=1 (or N₁=1 and N₂>1). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 10 where “X” represents two antenna polarizations. In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g. X=3000, then antenna ports are 3000, 3001, 3002, . . . ). Dual-polarized antenna payouts are provided in this disclosure. The embodiments (and examples) in this disclosure however are general and are applicable to single-polarized antenna layouts as well.

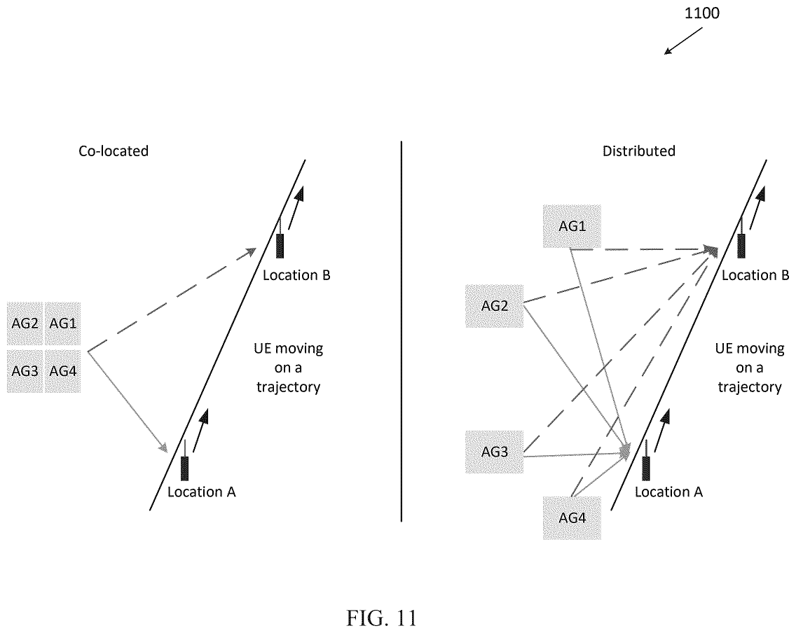

FIG. 11 illustrates examples of a UE moving on a trajectory 1100, with AGs of the BS co-located and distributed according to embodiments of the present disclosure. For example, trajectory 1100 with AGs of the BS co-located and distributed can be implemented by any of the UEs 111-116 of FIG. 1. This example is for illustration only and can be used without departing from the scope of the present disclosure.

Let N_{g} be a number of antenna groups (AGs). When there are multiple antenna groups (N_{g}>1), each group (g∈{1, . . . , N_{g}}) comprises dual-polarized antenna ports with N_{1,g} and N_{2,g} ports in two dimensions. This is illustrated in FIG. 10. Note that the antenna port layouts may be the same (N_{1,g}=N₁ and N_{2,g}=N₂) in different antenna groups, or they can be different across antenna groups. For group g, the number of antenna ports is P_{CSIRS,g}=N_{1,g}N_{2,g} or 2N_{1,g}N_{2,g} (for co-polarized or dual-polarized respectively).

In one example, an antenna group corresponds to an antenna panel. In one example, an antenna group corresponds to a TRP. In one example, an antenna group corresponds to an RRH. In one example, an antenna group corresponds to CSI-RS antenna ports of a non-zero-power (NZP) CSI-RS resource. In one example, an antenna group corresponds to a subset of CSI-RS antenna ports of a NZP CSI-RS resource (comprising multiple antenna groups). In one example, an antenna group corresponds to CSI-RS antenna ports of multiple NZP CSI-RS resources (e.g. comprising a CSI-RS resource set).

In one example, an antenna group corresponds to a reconfigurable intelligent surface (RIS) in which the antenna group can be (re-)configured more dynamically (e.g. via MAC CE or/and DCI). For example, the number of antenna ports associated with the antenna group can be changed dynamically.

In one example scenario, multiple AGs can be co-located or distributed, and can serve static (non-mobile) or moving UEs. An illustration of AGs serving a moving UE is shown in FIG. 11. While the UE moves from a location A to another location B, the UE measures the channel, e.g. via NZP CSI-RS resources, (may also measure the interference, e.g. via CSI-IM resources or CSI-RS resources for interference measurement), uses the measurement to determine/report CSI or calibration-related information taking into account joint transmission from multiple AGs.

In one example, the antenna architecture of the MIMO system is structured. For example, the antenna structure at each AG is dual-polarized (single or multi-panel as shown in FIG. 10. The antenna structure at each AG can be the same. Or, the antenna structure at an AG can be different from another AG. Likewise, the number of ports at each AG can be the same. Or, the number of ports at one AG can be different from another AG.

In another example, the antenna architecture of the MIMO system is unstructured. For example, the antenna structure at one AG can be different from another AG.

A structured antenna architecture is provided in/for the rest of the disclosure. For simplicity, each AG is equivalent to a panel (cf. FIG. 10), although, an AG can have multiple panels in practice. The disclosure however is not restrictive to a single panel expectation at each AG, and can easily be extended (covers) the case when an AG has multiple antenna panels.

In one embodiment, an AG constitutes (or corresponds to or is equivalent to) at least one of the following:
In one example, an AG corresponds to a TRP.
In one example, an AG corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained herein in this disclosure.
In one example, an AG corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained herein in this disclosure. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an AG corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an AG. The information about the subsets of ports or grouping of ports can be provided together with the CSI-RS resource setting/configuration, or with the CSI reporting setting/configuration, or with the CSI-RS resource configuration.
In one example, an AG corresponds to one or more examples described herein depending on a configuration. For example, this configuration can be explicit via a parameter (e.g. an RRC parameter). Or, it can be implicit.
   In one example, when implicit, it could be based on the value of K. For example, when K>1 CSI-RS resources, an AG corresponds to one or more examples described herein, and when K=1 CSI-RS resource, an AG corresponds to one or more examples described herein.
   In another example, the configuration could be based on the configured codebook. For example, an AG corresponds to a CSI-RS resource (according to one or more examples described herein) or resource group (according to one or more examples described herein) when the codebook corresponds to a decoupled codebook (modular or separate codebook for each AG), and an AG corresponds to a subset (or a group) of CSI-RS ports (according to one or more examples described herein) when codebook corresponds to a coupled (joint or coherent) codebook (one joint codebook across AGs).

In one example, when AG maps (or corresponds to) a CSI-RS resource or resource group (according to one or more examples described herein), and a UE can select a subset of AGs (resources or resource groups) and report the CSI or calibration-related information for the selected AGs (resources or resource groups), the selected AGs can be reported via an indicator (e.g. via UCI part 1 of a two-part UCI). For example, the indicator can be a channel quality indicator (CQI) report interval (CRI) or a PMI (component) or a new indicator (e.g. a bitmap).

In one example, when AG maps (or corresponds to) a CSI-RS port group (according to one or more examples described herein), and a UE can select a subset of AGs (port groups) and report the CSI or calibration-related information for the selected AGs (port groups), the selected AGs can be reported via an indicator (e.g. via UCI part 1 of a two-part UCI). For example, the indicator can be a CRI or a PMI (component) or a new indicator (e.g. a bitmap).

In one example, CSI-RS herein in this disclosure comprises at least one or a combination of the following: CSI-RS for tracking (TRS), CSI-RS for CSI, CSI-RS for beam management (BM), CSI-RS for mobility or NZP CSI-RS resource for IMR (interference measurement) or a new type/usage of CSI-RS, namely, CSI-RS for calibration.

In one embodiment, a UE is configured with a calibration mechanism, wherein the UE is configured to perform one or more UL RS transmission(s), or/and to perform one or more DL RS reception(s)/measurement(s), and/or to report calibration-related information (e.g., for calibration coefficient for each TRP).

This configuration can be performed via higher-layer (RRC) signaling.
In one example, this configuration corresponds to a CSI resource setting configured via a higher layer IE CSI-ResourceConfig.
In one example, this configuration corresponds to a CSI resource set configured via a higher layer IE NZP-CSIRSResourceSet.
In one example, this configuration corresponds to a NZP CSI resource configured via a higher layer IE NZP-CSIRSResource.
In one example, this configuration corresponds to a CSI report setting configured via a higher layer IE CSI-ReportConfig.

In one example, the DL RS(s) can be one of or multiple of CSI-RS for CSI reporting, CSI-RS for tracking (TRS), CSI-RS for beam reporting, DL DMRS, or synchronization signal/physical broadcast channel (SSB/PBCH) or a new type/usage of CSI-RS, namely, CSI-RS for calibration. In one example, DL RS can be a dedicated or new DL RS (for calibration purpose).

In one example, the UL RS(s) can be one of or multiple of SRS with usage=CB, SRS with usage=non-CB, SRS with usage=beamManagement, SRS with usage-AntennaSwitching, or UL DMRS. In one example, UL RS can be a dedicated or new UL RS (for calibration purpose).

In one example, the DL RS(s) can be aperiodic (AP) only.

In one example, the DL RS(s) can be AP or semi-persistent (SP).

In one example, the DL RS(s) can be AP or periodic (P).

In one example, the DL RS(s) can be SP or P.

In one example, the DL RS(s) can be AP or SP or P.

In one example, the UL RS(s) can be aperiodic (AP) only.

In one example, the UL RS(s) can be AP or semi-persistent (SP).

In one example, the UL RS(s) can be AP or periodic (P).

In one example, the UL RS(s) can be SP or P.

In one example, the UL RS(s) can be AP or SP or P.

In one example, the reporting can only be AP. In this case, the reporting can be triggered via a DCI (e.g. a CSI request field in UL-DCI).

In one example, the reporting can either be AP or SP. For AP, the reporting can be triggered via a DCI (e.g. a CSI request field in UL-DCI), and for SP, it can be triggered via MAC CE or DCI.

In one example, the reporting can only be UE-initiated (or UE-triggered). In this case, the reporting can be triggered via UL MAC CE (e.g. MAC CE for power headroom report (PHR) reporting) or via a pre-notification message sent by the UE, where this message can be sent via SR (scheduling request) or via UCI (a pre-configured PUCCH or a PUSCH).

The term ‘precoder’ in this disclosure can be replaced with a spatial information (or transmission configuration indication (TCI) state, or spatialRelationInfo) or source RS or spatial filter, beamformer, beamforming vectors/matrices, precoding vector/matrices, or any other functionally equivalent quantity, that can be used for DL/UL RS reception/transmission.

In one embodiment, a UE (e.g., the UE 116) is configured with a measurement and a report (e.g. CSI or calibration report) including calibration-related information (CLI) to enable/facilitate calibration/synchronization across Nₜᵣₚ≥1 TRPs or AGs or CSI-RS resources. In one example, the measurement can be configured via higher layer IE CSI-ResourceConfig indicating S≥1 sets of NZP CSI-RS resources. In one example, the measurement can be configured via higher layer IE NZP-CSIRS-ResourceSet indicating a set of NZP CSI-RS resources. In one example, the measurement can be configured via higher layer IE MeasObj. In one example, the report can be configured via higher layer parameter CSI-ReportConfig with reportType set to a new value, e.g. ‘calibration’ or ‘cjt-calibration’.

Let hr be the measurement associated with r-th TRP (or CSI-RS resource or DL RS), where

$$r = 1 , … , N and H = [ \begin{matrix}{h}_{1} ( t - δ {t}_{1} , f - δ {f}_{1} ) \\ {h}_{2} ( t - δ {t}_{2} , f - δ {f}_{2} ) \\ ⋮ \\ {h}_{N} ( t - δ {t}_{N} , f - δ {f}_{N} )\end{matrix} ]$$

be the composite/aggregated channel at a T-F unit (t, f) and {(δtᵣ, δfᵣ)} be the offsets associated with TRPs.

As described in this disclosure, one of the N TRPs can be a reference, whose offset can be fixed, e.g. to zero. Without loss generality, the reference TRP (resource) corresponds to (the 1^{st}

$$TRP ) {r}^{*} = 1 for which ( δ {t}_{1} , δ {f}_{1} ) = ( 0 , 0 ) , i . e . , H = [ \begin{matrix}{h}_{1} ( t , f ) \\ {h}_{2} ( t - δ {t}_{2} , f - δ {f}_{2} ) \\ ⋮ \\ {h}_{N} ( t - δ {t}_{N} , f - δ {f}_{N} )\end{matrix} ] .$$

In one example, values of (δtᵣ, δfᵣ), based on the measurement, can be used to determine the report.

In one example, a low-pass or a window-based approach can be used for the report. In one example, the window corresponds to value of (δtᵣ, δfᵣ) that are around the reference. For instance, δtᵣ≤Wₜ and/or δfᵣ≤W_{f}, where (Wₜ, W_{f}) corresponds to the window length or max value of (δtᵣ, δ_{fr}) that can be used for the report, (Wₜ, W_{f}) can be fixed, or configured, or reported by the UE.

In one example, the unit of CLI reporting is at least one of the following examples:
In one example, for time offset, the unit can be based on the CP length, or the symbol duration, or the slot duration. For example, 2^{N}^{_{T}} values within a window/interval, [0, x], x=CP length, min measurement interval. In one example, x=4.69×10⁻⁶ sec or 4.69μ sec. In one example, x=2^{z}×4.69×10⁻⁶ sec or 4.69μ sec where z∈{0, 1, 2, 3, 4}.
In one example, for time offset, the unit can be based on a fractional factor (between 0 and 1) of a TD unit. For example, 2^{N}^{_{T}} values within a window/interval, [0, x], x=TD unit length.
In one example, For frequency error (in ppm), the unit can be based on the window/interval, [0, x] or [−x, x], x=freq. error value specified in 38.104 (from RAN4). For example, 2^{N}^{_{F}} values within a window/interval, [0, x] or [−x, x], x=FD unit length. In one example, x=0.05 ppm (parts per million).
In one example, for time offset, the unit can be based on the normalized CP length, or the symbol duration, or the slot duration. For example, 2^{N}^{_{T}} values within a window/interval, [0, 1], 1 corresponds to CP length, min measurement interval. In one example, the CP length x=4.69×10⁻⁶ sec or 4.69μ sec. In one example, the CP length x=2^{z}×4.69×10⁻⁶ sec or 4.69μ sec where z∈{0, 1, 2, 3, 4}.
In one example, for time offset, the unit can be based on a normalized fractional factor (between 0 and 1) of a TD unit. For example, 2^{N}^{_{T}} values within a window/interval, [0, 1], 1 corresponds to TD unit length.
In one example, for frequency error (in ppm), the unit can be based on the normalized window/interval, [0, 1] or [−1, 1], 1 corresponds to freq. error value, e.g., specified in 38.104 (from RAN4). For example, 2^{N}^{_{F}} values within a window/interval, [0, 1] or [−1, 1], x=FD unit length. In one example, x=0.05 ppm (parts per million).

Note that CP length can be also expressed as

$$C P = \frac{144}{2056} \cdot \frac{1}{Δ f} \approx \frac{1}{14} \cdot \frac{1}{Δ f} ,$$

where Δf is subcarrier spacing, e.g., Δf=15, 30, 60, 120 (or etc) kHz. Or CP length can also be expressed as normal CP length or extended CP length, i.e., normal

$$CP length = \frac{144}{2056} \cdot \frac{1}{Δ f} \approx \frac{1}{14} \cdot \frac{1}{Δ f}$$

and extended

$$CP length = \frac{512}{2056} \cdot \frac{1}{Δ f} = \frac{1}{4} \cdot \frac{1}{Δ f} .$$

In this disclosure, CP length can be replaced by

$$\frac{144}{2056} \cdot \frac{1}{Δ f}$$

or 2^{z}×4.69×10⁻⁶ or an approximated CP length

$$\frac{1}{14} \cdot \frac{1}{Δ f}$$

or an extended or length

$$\frac{1}{4} \cdot \frac{1}{Δ f} .$$

In one example, the CLI corresponds to at least one indicator indicating a measurement RS. For instance, the indicator can be CRI or SSB resource indicator (SSBRI) or other DL RS indicator when the measurement RS is NZP CSI-RS or SSB/PBCH block, or another DL RS. The at least one indicator can provide an implicit information about the offsets.

In one example, the CLI corresponds to the set of values of N or N−1 pairs {(δtᵣ, δfᵣ)} or indicator(s) indicating (quantized) values of {(δtᵣ, δfᵣ)}. At least one of the following examples of alphabet set is used for quantizing {(δtᵣ, δfᵣ)}.
In one example, the alphabet set corresponds to a uniform quantizer Qᵤₙᵢ in linear scale.
   In one example, Qᵤₙᵢ includes 2^{B} values, uniformly/equally spaced/separated in [0, v], where B is the number of bits for quantization and v is the max value. In one example, the 2^{B} values include 0 or/and v.
      In one example, for time, v=sT_{CP} where T_{CP} is the CP length, and s is a scaling. In one example, s=1.
      In one example, for time, v=sTₛₗₒₜ where Tₛₗₒₜ is the slot duration, and s is a scaling. In one example, s=1.
      In one example, for frequency, v=sFₘᵢₙ where Fₘᵢₙ is the min requirement on the frequency error, e.g. in parts per million (ppm).
   In one example, Qᵤₙᵢ includes 2^{B} values, uniformly/equally spaced/separated in [u, v] where B is the number of bits for quantization, u is the min value, and v is the max value. In one example, the 2^{B} values include u or/and v.
   In one example, Qᵤₙᵢ includes 2^{B} values, uniformly/equally spaced/separated in [−v/2, v/2].
In one example, the alphabet set corresponds to a uniform quantizer Qᵤₙᵢ in logarithmic scale.
In one example, the alphabet set corresponds to a non-uniform (e.g. exponential) quantizer Qₙₒₙ₋ᵤₙᵢ.
   In one example, Qₙₒₙ₋ᵤₙᵢ includes Rel.15 3-bit amplitude alphabet set (Table 1).
   In one example, Qₙₒₙ₋ᵤₙᵢ includes Rel.16 3-bit or 4-bit amplitude alphabet set (Table 2, Table 3).
   In one example, Qₙₒₙ₋ᵤₙᵢ includes Rel.18 amplitude alphabet set for time-domain channel property (TDCP) report (Table 4).

TABLE 1
$Mapping of elements of {k}_{l , i}^{( 1 )} to {p}_{l , i}^{( 1 )}$

| ${k}_{l , i}^{( 1 )}$ | ${p}_{l , i}^{( 1 )}$ |
|---|---|
| 0 | 0 |
| 1 | \sqrt{1/64} |
| 2 | \sqrt{1/32} |
| 3 | \sqrt{1/16} |
| 4 | \sqrt{1/8} |
| 5 | \sqrt{1/4} |
| 6 | \sqrt{1/2} |
| 7 | 1 |

TABLE 2
$Mapping of elements of {k}_{l , i}^{( 1 )} to {p}_{l , i}^{( 1 )}$

| ${k}_{l , p}^{( 1 )}$ | ${p}_{l , p}^{( 1 )}$ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

TABLE 3
$Mapping of elements of {k}_{l , i}^{( 1 )} to {p}_{l , i}^{( 1 )}$

| ${k}_{l , i , f}^{( 2 )}$ | ${p}_{l , i , f}^{( 2 )}$ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

TABLE 4
Mapping of elements kᵢ to aᵢ

| kᵢ | aᵢ |
|---|---|
| 0 | $\frac{1}{256}$ |
| 1 | $\frac{1}{128 \sqrt{2}}$ |
| 2 | $\frac{1}{128}$ |
| 3 | $\frac{1}{64 \sqrt{2}}$ |
| 4 | $\frac{1}{64}$ |
| 5 | $\frac{1}{32 \sqrt{2}}$ |
| 6 | $\frac{1}{32}$ |
| 7 | $\frac{1}{16 \sqrt{2}}$ |
| 8 | $\frac{1}{16}$ |
| 9 | $\frac{1}{8 \sqrt{2}}$ |
| 10 | $\frac{1}{8}$ |
| 11 | $\frac{1}{4 \sqrt{2}}$ |
| 12 | $\frac{1}{4}$ |
| 13 | $\frac{1}{2 \sqrt{2}}$ |
| 14 | $\frac{1}{2}$ |
| 15 | $\frac{1}{\sqrt{2}}$ |

In one example, for delay reporting, the alphabet set includes at least one value corresponding to a value larger than the CP length.
In one example, the alphabet set includes 2^{B} values in [0, x, x₁] where x₁>x and here x is the CP length, as described herein.
In one example, the alphabet set includes 2^{B} values in [0, 1, x₁] (normalized by the CP length) where x_{1>}1 and here 1 corresponds to the CP length, as described herein.
In one example, the alphabet set includes 2^{B} values in [y, x, x₁] where 0<y, x₁>x and here x is the CP length, as described herein.
In one example, the alphabet set includes 2^{B} values in [y, 1, x₁] (normalized by the CP length) where 0<y, x_{1>}1 and here 1 corresponds to the CP length, as described herein.

In one example, for delay reporting, the alphabet set includes M≥1 values corresponding to values larger than the CP length.
In one example, the alphabet set includes 2^{B} values in [0,x, x₁, . . . , x_{M}] where xₘ>x, m=1, . . . , M, and here x is the CP length, as described herein.
In one example, the alphabet set includes 2^{B} values in [0, 1, x₁, . . . , x_{M}] (normalized by the CP length) where xₘ>1, m=1, . . . , M, and here 1 corresponds to the CP length, as described herein.
In one example, the alphabet set includes 2^{B} values in [y, x, x₁, . . . , x_{M}] where 0<y, xₘ>x, m=1, . . . , M and here x is the CP length, as described herein.
In one example, the alphabet set includes 2^{B} values in [y, 1, x₁, . . . , x_{M}] (normalized by the CP length) where 0<y, xₘ>1, m=1, . . . , M and here 1 corresponds to the CP length, as described herein.

In one example, for delay reporting, the alphabet set includes at least one code point P indicating that delay value is larger than the CP length or corresponds to a value larger than the CP length.
In one example, the alphabet set includes 2^{B} values in [0, x, a] where x is the CP length, as described herein. The code point P indicates a. In one example, a corresponds to NULL, Invalid, or a fixed value larger than x, or out-of-range.
In one example, the alphabet set includes 2^{B} values in [0, 1, a] (normalized by the CP length) where 1 corresponds to the CP length, as described herein. The code point P indicates a. In one example, a corresponds to NULL, Invalid, or a fixed value larger than x or out-of-range.
In one example, the alphabet set includes 2^{B} values in [y, x, a] where 0<y, x is the CP length, as described herein. The code point P indicates a. In one example, a corresponds to NULL, Invalid, or a fixed value larger than x or out-of-range.
In one example, the alphabet set includes 2^{B} values in [y, 1, a] (normalized by the CP length) where 0<y, 1 corresponds to the CP length, as described herein. The code point P indicates a. In one example, a corresponds to NULL, Invalid, or a fixed value larger than x or out-of-range.

In one example, for delay reporting, the alphabet set includes at least one code point P indicating that delay value is larger than the CP length or corresponds to a value larger than the CP length, or/and includes M≥1 values corresponding to values larger than the CP length.
In one example, the alphabet set includes 2^{B} values in [0, x, x₁, . . . , x_{M}, a] where x is the CP length and xₘ, as described herein. The code point P indicates a. In one example, a corresponds to NULL, Invalid, or a fixed value larger than x or out-of-range.
In one example, the alphabet set includes 2^{B} values in [0, 1, x₁, . . . , x_{M}, a] (normalized by the CP length) where 1 corresponds to the CP length and xₘ, as described herein. The code point P indicates a. In one example, a corresponds to NULL, Invalid, or a fixed value larger than x or out-of-range.
In one example, the alphabet set includes 2^{B} values in [y, x, x₁, . . . , x_{M}, a] where 0<y, x is the CP length and xₘ, as described herein. The code point P indicates a. In one example, a corresponds to NULL, Invalid, or a fixed value larger than x or out-of-range.
In one example, the alphabet set includes 2^{B} values in [y, 1, x₁, . . . , x_{M}, a] (normalized by the CP length) where 0<y, 1 corresponds to the CP length and xₘ, as described herein. The code point P indicates a. In one example, a corresponds to NULL, Invalid, or a fixed value larger than x or out-of-range.

In one example, M is fixed (e.g. 1). In one example, M is configured (e.g. RRC). In one example, M is reported by the UE.

In one example, x₁=x+δ, and δ is fixed (e.g. 1/t and t is an integer), is configured (e.g. RRC), is reported by the UE.

In one example, xₘ=x+δₘ, and δₘ is fixed (e.g.

$$\frac{1}{{t}_{m}}$$

and tₘ is an integer), is configured (e.g. RRC), is reported by the UE.

In one example, for frequency error reporting, the alphabet set includes at least one value corresponding to a value larger than the frequency error (x).
In one example, the alphabet set includes 2^{B} values in [0, x, x₁] or [−x₁, −x, x, x₁] where x₁>x and here x is the frequency error, as described herein.
In one example, the alphabet set includes 2^{B} values in [0, 1, x₁] or [−x₁, −1, 1, x₁] (normalized by the frequency error) where x_{1>}1 and here 1 corresponds to the frequency error, as described herein.
In one example, the alphabet set includes 2^{B} values in [y, x, x₁] where 0<y, x₁>x and here x is the frequency error, as described herein.
In one example, the alphabet set includes 2^{B} values in [y, 1, x₁] (normalized by the frequency error) where 0<y, x_{1>}1 and here 1 corresponds to the frequency error, as described herein.

In one example, for frequency error reporting, the alphabet set includes M≥1 values corresponding to values larger than the frequency error.
In one example, the alphabet set includes 2^{B} values in [0, x, x₁, . . . , x_{M}] where xₘ>X, m=1, . . . , M, and here x is the CP length, as described herein.
In one example, the alphabet set includes 2^{B} values in [0, 1, x₁, . . . , x_{M}] (normalized by the Frequency error) where xₘ>1, m=1, . . . , M, and here 1 corresponds to the Frequency error, as described herein.
In one example, the alphabet set includes 2^{B} values in [y, x, x₁, . . . , x_{M}] where 0<y, xₘ>x, m=1, . . . , M and here x is the Frequency error, as described herein.
In one example, the alphabet set includes 2^{B} values in [y, 1, x₁, . . . , x_{M}] (normalized by the Frequency error) where 0<y, xₘ>1, m=1, . . . , M and here 1 corresponds to the Frequency error, as described herein.

In one example, for frequency error reporting, the alphabet set includes at least one code point P indicating that delay value is larger than the Frequency error or corresponds to a value larger than the Frequency error.
In one example, the alphabet set includes 2^{B} values in [0, x, a] where x is the Frequency error, as described herein. The code point P indicates a. In one example, a corresponds to NULL, Invalid, or a fixed value larger than x.
In one example, the alphabet set includes 2^{B} values in [0, 1,a] (normalized by the Frequency error) where 1 corresponds to the Frequency error, as described herein. The code point P indicates a. In one example, a corresponds to NULL, Invalid, or a fixed value larger than x.
In one example, the alphabet set includes 2^{B} values in [y, x, a] where 0<y, x is the Frequency error, as described herein. The code point P indicates a. In one example, a corresponds to NULL, Invalid, or a fixed value larger than x.
In one example, the alphabet set includes 2^{B} values in [y, 1, a] (normalized by the Frequency error) where 0<y, 1 corresponds to the Frequency error, as described herein. The code point P indicates a. In one example, a corresponds to NULL, Invalid, or a fixed value larger than x.

In one example, for frequency error reporting, the alphabet set includes at least one code point P indicating that delay value is larger than the Frequency error or corresponds to a value larger than the Frequency error, or/and includes M≥1 values corresponding to values larger than the Frequency error.
In one example, the alphabet set includes 2^{B} values in [0, x, x₁, . . . , x_{M}, a] where x is the Frequency error and xₘ, as described herein. The code point P indicates a. In one example, a corresponds to NULL, Invalid, or a fixed value larger than x.
In one example, the alphabet set includes 2^{B} values in [0, 1, x₁, . . . , x_{M}, a] (normalized by the Frequency error) where 1 corresponds to the Frequency error and xₘ, as described herein. The code point P indicates a. In one example, a corresponds to NULL, Invalid, or a fixed value larger than x.
In one example, the alphabet set includes 2^{B} values in [y, x, x₁, . . . , x_{M}, a] where 0<y, x is the Frequency error and xₘ, as described herein. The code point P indicates a. In one example, a corresponds to NULL, Invalid, or a fixed value larger than x.
In one example, the alphabet set includes 2^{B} values in [y, 1, x₁, . . . , x_{M}, a] (normalized by the Frequency error) where 0<y, 1 corresponds to the Frequency error and xₘ, as described herein. The code point P indicates a. In one example, a corresponds to NULL, Invalid, or a fixed value larger than x.

In one example, M is fixed (e.g. 1). In one example, M is configured (e.g. RRC). In one example, M is reported by the UE.

In one example, x₁=x+δ, and δ is fixed (e.g. 1/t and t is an integer), is configured (e.g. RRC), is reported by the UE.

In one example, xₘ=x+δₘ, and δₘ is fixed (e.g.

$$\frac{1}{{t}_{m}}$$

and tₘ is an integer), IS configured (e.g. RRC), is reported by the UE.

In one example, the CLI corresponds to the set of values of N−1 phases {ϕᵣ} associated with (or due to) {(δtᵣ, δfᵣ)} or indicator(s) indicating (quantized) values of {ør}. In one example, ϕᵣ=e^{j2π(f+δf}^{ᵣ}^{)(t+δt}^{ᵣ}⁾. At least one of the following examples of the alphabet set is used for quantizing {(δtᵣ, δfᵣ)}. In one example, the alphabet set corresponds 2^{e}=N_{PSK} bit alphabet set.
In one example, e=1. The 2 values corresponds to binary phase-shift keying (BPSK) [1, −1].
In one example, e=2. The 4 values corresponds to quadrature phase shift keying (QPSK)[1, j, −1, −j].
In one example, e=3. The 8 values corresponds to 8PSK

$$\{ {e}^{j \frac{2 π k}{8}} : k = 0 , 1 , … , 7 \} .$$

In one example, e=4. The 16 values corresponds to 16PSK

$$\{ {e}^{j \frac{2 π k}{16}} : k = 0 , 1 , … , 15 \} .$$

In one example, e is configured via higher layer signaling, e.g. from {3, 4}.

In one example, the UE (e.g., the UE 116) also reports (indices indicating) the values of {(δtᵣ, δfᵣ)} associated with the reported {ϕᵣ}. In one example, the UE is configured with (indices indicating) the values of {(δtᵣ, δfᵣ)}.

In one example, the CLI can also include amplitude in addition to phase, i.e., c, =aᵣϕᵣ.

At least one of the following examples is used/configured regarding the reporting/calculation.

In one example, the reporting is absolute, i.e., each of N values is determined/reported independently from other values.

In one example, the reporting is differential (relative) w.r.t. a base or reference. In one example, the based or reference is r=0, the 1^{st} TRP (resource). That is, the offset value corresponding to r>0 is reported/determined w.r.t. to the same corresponding to r=0. In one example, the reference can be fixed (e.g. 0), or configured (e.g. via higher layer) or reported by the UE (as part of the CSI report, either via part 1 or part 2 of a two-part UCI). In one example, the normalized value of the reference can also be reported by the UE.
In one example, the differential/relative offset value is determined as v′(r)=v(r)−v(0). The UE reports correlation v(0) for r=0, and c′(v) for v≠0.
In one example, the differential/relative offset is determined as

$${v}^{′} ( r ) = \frac{v ( r )}{v ( 0 )} .$$

The UE reports offset v(0) for r=0, and v′(r) for r≠0.
In one example, vₜ=vₜ₋₁+\tilde{v}t or vₜ=vₜ₋₁×\tilde{v}ₜ.
In one example, vₜ=v₀+\tilde{v}ₜ or vₜ=v₀×\tilde{v}ₜ.

In one example, the report is a standalone/separate report (similar to Rel.18 time-domain channel property, TDCP), and doesn't include any other parameters. The report can be reported via a layer 1 (physical) UL channel such as PUCCH or/and PUSCH. In this case, the report can be multiplexed with other UCI parameters such as HARQ-ACK parameters. Alternatively, the report can be reported via a layer 2 (MAC) UL channel such as UL MAC CE. In this case, the report can be multiplexed with other MAC parameters such as PHR parameters.

In one example, the report is a non-standalone/joint report and can include other parameters such as CSI parameters (e.g. rank indicator (RI), precoding matrix indicator (PMI), channel quality indicator (CQI), CQI report interval (CRI), layer index (LI)) or/and beam-related parameters (e.g. L1-reference signal received power (RSRP), L1-signal-to-interference-plus-noise ratio (SINR), CRI, SSBRI). In this case, the (calibration) report is a component (or part of) out of multiple components (or parts of) the CSI/beam report.

In one example, the CLI can be included as a component of (part of an alphabet set), e.g. Rel.18 Type II CJT alphabet set, and the corresponding configuration can be codebookMode=mode 3 (in addition to mode 1 and mode 2 in Rel. 18).

In one example, a metric to obtain/derive/obtain the CLI is based on auto-(/cross-) correlation or/and power spectrum or power spectrum density of the measurement.

In one example, the measurement and reporting for T-F offset is decoupled/separate, i.e., one of the two separate mechanisms can be configured/used.
For time offset (δtᵣ), the measurement corresponds to multiple (a burst of) time occasions, where two consecutive time occasions can be separated by d symbols or slots.
For frequency offset (δfᵣ), the measurement corresponds to multiple (a burst of) frequency occasions, where two consecutive frequency occasions can be separated by d subcarriers or PRBs or SBs.

In one example, the measurement and reporting for T-F offset is coupled/joint, i.e., one joint mechanism is used/configured for a 2D measurement and reporting for (δtᵣ, δfᵣ).

At least one of the following examples is used/configured regarding the frequency domain granularity of the reporting/calculation of offset value(s).
In one example, the reporting/calculation of offset value(s) is in a wideband (WB) manner, i.e., offset values are reported common for the entire CSI reporting band.
In one example, the reporting/calculation of offset value(s) is in a subband (SB) manner, i.e., offset values are reported for each SB in the CSI reporting band. In addition, a reference (WB) offset can also be reported such that Sub-band offset level(s)=sub-band offset index(s)−wideband offset index.

Likewise, at least one of the following examples is used/configured regarding the time domain granularity of the reporting/calculation of offset value(s).
In one example, the reporting/calculation of offset value(s) is in a wide-time (WT) manner, i.e., offset values are reported common for the entire time window or duration (in which the report is expected to be valid).
In one example, the reporting/calculation of offset value(s) is in a sub-time (ST) manner, i.e., offset values are reported for each ST in the time duration (in which the report is expected to be valid). In addition, a reference (WT) offset can also be reported such that ST offset level(s)=ST offset index(s)−WT offset index.

In one example, the report includes one value for each TRP (N values when including the reference or N−1 values when excluding the reference). For time/delay offsets (Dᵣ delay values d_{r,0}, . . . , d_{r,D}_{ᵣ}₋₁ sorted in increasing order)
In one example, the one value corresponds to the 1^{st} delay d_{r,0}.
In one example, the one value corresponds to the last delay d_{r,D}_{ᵣ}₋₁.
In one example, the one value corresponds to the max of {d_{r,i}_{ᵣ}}, iᵣ=0, . . . , Dᵣ−1.
In one example, the one value corresponds to the Delay spread DSᵣ=d_{r,D}_{ᵣ}₋₁−d_{r,0}.

Likewise, for frequency offsets (Fᵣ values f_{r,0}, . . . , f_{r,F}_{ᵣ}₋₁ sorted in increasing order)
In one example, the one value corresponds to the 1^{st} frequency f_{r,0}.
In one example, the one value corresponds to the last frequency f_{r,F}_{ᵣ}₋₁.
In one example, the one value corresponds to the max of {f_{r,i}_{ᵣ}}, iᵣ=0, . . . , Fᵣ−1.
In one example, the one value corresponds to the Frequency spread FSᵣ=f_{r,F}_{ᵣ}₋₁−f_{r,0}.

In one example, the report includes two values for each TRP. For time/delay offsets (Dᵣ delay values d_{r,0}, . . . , d_{r,D}_{ᵣ}₋₁ sorted in increasing order),
In one example, the two values can correspond to the 1^{st} and the last values d_{r,0} and d_{r,D}_{ᵣ}₋₁.
In one example, the two values can correspond to the max and the min of {d_{r,i}_{ᵣ}}, iᵣ=0, . . . , Dᵣ−1.
In one example, the two values can correspond to the two largest values of {d_{r,i}_{ᵣ}}, iᵣ=0, . . . , Dᵣ−1.

Likewise, For frequency offsets (Fr values f_{r,0}, . . . , f_{r,F}_{ᵣ}₋₁ sorted in increasing order),
In one example, the two values can correspond to the 1^{st} and the last values f_{r,0} and f_{r,F}_{ᵣ}₋₁.
In one example, the two values can correspond to the max and the min of {f_{r,i}_{ᵣ}}, iᵣ=0, . . . , Fᵣ−1.
In one example, the two values can correspond to the two largest values of {f_{r,i}_{ᵣ}}, iᵣ=0, . . . , Fᵣ−1.

In one example, the report includes two values for each TRP.

In one example, the report includes two values for N−1 TRPs (excluding the reference TRP).

In one example, the report includes one value v_{ref} for the reference TRP, and two values for remaining TRPs, i.e., the two values for the reference are 0 and v_{ref}.

In one example, the report further includes a recommendation about coherency (CJT or NCJT) across TRPs. In one example, it can be implicit via one value, or explicit via an indicator (e.g. 1-bit), or via an Nₜᵣₚ-bit or N-bit bitmap indicator, where when the bitmap is ‘0’ or ‘1’ then it indicates NCJT and when at least two ‘1’s or ‘0’s then it indicates CJT.

In one embodiment, a CLI reporting (described in an example of embodiments herein) is according to at least one of the following examples.

In one example, the CLI reporting includes one CRI (or DL RS indicator) to indicate a reference CSI-RS resource.

In one example, the CSI reporting does not include any CRI information.
In one example, a reference CSI-RS resource can be configured by the NW, via higher-layer signaling (i.e., RRC).
In one example, a reference CSI-RS resource is fixed, e.g., the lowest (or highest) index of CSI-RS resources.
In one example, a reference CSI-RS resource is not indicated/reported/specified/used.

In one example, the CLI reporting includes a Nₜᵣₚ-bit bitmap indicator (or N≤Nₜᵣₚ-bit bitmap indicator) to indicate one or multiple CSI-RS resources.

In one embodiment, for (inter-TRP-)delay reporting (of a CLI reporting described in one or more examples herein), an alphabet set for quantizing delay values is according to at least one of the following examples.

In one example, the alphabet set includes 0 value or a codepoint mapping to 0 value.

In one example, the alphabet set does not include 0 value or a codepoint mapping to 0 value.

In one example, the alphabet set includes 2^{B} values or codepoints for a range of [y, xₘₐₓ] in unit of CP length, where y can be fixed, e.g., y=1, or y<1, or y>1, or can be configured by the NW via higher-layer signaling (i.e., RRC), or can be determined by the UE, and where xₘₐₓ>y is maximum a value of the range (e.g., xₘₐₓ=a value less than 1, 1, 1.1, 1.2, 1.3, 1.4, 1.5, 1.6, 1.7, 1.8, 1.9, 2, 2.5, 3, a value larger than 3) and it can be fixed, configured by the NW, or determined by the UE.
In one example, B=0, 1, 2, 3, 4, 5, 6, 7, or 8 or a larger value than 8 is fixed. In another example, B can be configured by the NW. In another example, B can be determined by the UE and reported as a part of the reporting.
In one example, the 2^{B} values (or codepoints) are values in [y, xₘₐₓ] in unit of CP length.
In one example, the 2^{B} values (or codepoints) are values in [0, xₘₐₓ−y] in unit of CP length.
In one example, the 2^{B} values (or codepoints) includes 0 value.
In one example, the 2^{B} values (or codepoints) includes a reserved value, e.g., NULL, out-of-range, etc.

In one example, more specifically, the alphabet set includes 2^{B}=M codepoints where M−1 codepoints correspond to intervals in [0, A_{D}] in unit of CP length (where A_{D}=xₘₐₓ−y) and 1 codepoint corresponds to a reserved value (e.g., out-of-range, invalid state, NULL, etc.). In one example, each codepoint i of the M−1 codepoints corresponds to an interval [δᵢ, δᵢ₊₁) (or (δᵢ, δᵢ₊₁], [δᵢ, δᵢ₊₁], or (δᵢ, δᵢ₊₁)), where {δ₀, δ₁, . . . , δ_{M-1}} is uniformly spaced between 0 and A_{D},

$${δ}_{i} = i \times \frac{{A}_{D}}{M - 1} ,$$

for i=0, 1, 2, . . . , M−1. The reserved value (e.g., out-of-range) can represent [A_{D}, ∞).

In one example, each codepoint i of the M−1 (or M−2) codepoints corresponds to an interval [δᵢ, δᵢ₊₁) (or (δᵢ, δᵢ₊₁], [δᵢ, δᵢ₊₁], or (δᵢ, δᵢ₊₁)), where {δ₀, δ₁, . . . , δ_{M-2}} is uniformly spaced between 0 and A_{D},

$${δ}_{i} = i \times \frac{{A}_{D}}{M - 2} ,$$

for i=0, 1, 2, . . . , M−2. The reserved value (e.g., out-of-range) can represent [A_{D}, ∞).

In one example, the alphabet set includes 2^{B} values or codepoints for a range of [y, xₘₐₓ] in (absolute) time unit, where y can be fixed, e.g., y=1×CP length, or y<1×CP length, or y>1×CP length, or can be configured by the NW via higher-layer signaling (i.e., RRC), or can be determined by the UE, and where xₘₐₓ>y is a maximum value of the range (e.g., xₘₐₓ=a value less than 1, 1, 1.1, 1.2, 1.3, 1.4, 1.5, 1.6, 1.7, 1.8, 1.9, 2, 2.5, 3, a value larger than 3×CP), and it can be fixed, configured by the NW, or determined by the UE.
In one example, B=0, 1, 2, 3, 4, 5, 6, 7, or 8 or a larger value than 8 is fixed. In another example, B can be configured by the NW. In another example, B can be determined by the UE and reported as a part of the reporting.
In one example, the 2^{B} values (or codepoints) are values in [y, xₘₐₓ] in (absolute) time unit.
In one example, the 2^{B} values (or codepoints) are values in [0, xₘₐₓ−y] in (absolute) time unit
In one example, the 2^{B} values (or codepoints) includes 0 value.
In one example, the 2^{B} values (or codepoints) includes a reserved value, e.g., NULL, out-of-range, etc.
In one example, more specifically, the alphabet set includes 2^{B}=M codepoints where M−1 codepoints correspond to intervals in [0, A_{D}] in (absolute) time unit (where A_{D}=xₘₐₓ−y) and 1 codepoint corresponds to a reserved value (e.g., out-of-range, invalid state, NULL, etc). In one example, each codepoint i of the M−1 codepoints corresponds to an interval [δᵢ, δᵢ₊₁) (or (δᵢ, δᵢ₊₁], [δᵢ, δᵢ₊₁], or (δᵢ, δᵢ₊₁)), where {δ₀, δ₁, . . . , δ_{M-1}} is uniformly spaced between 0 and A_{D},

$${δ}_{i} = i \times \frac{{A}_{D}}{M - 1} ,$$

for i=0, 1, 2, . . . , M−1. The reserved value (e.g., out-of-range) can represent [A_{D}, ∞) (or (A_{D}, ∞)).

In one example, each codepoint i of the M−1 (or M−2) codepoints corresponds to an interval [δᵢ, δᵢ₊₁) (or (δᵢ, δᵢ₊₁], [δᵢ, δᵢ₊₁], or (δᵢ, δᵢ₊₁)), where {δ₀, δ₁, . . . , δ_{M-2}} is uniformly spaced between 0 and A_{D},

$${δ}_{i} = i \times \frac{{A}_{D}}{M - 2} ,$$

for i=0, 1, 2, . . . , M−2. The reserved value (e.g., out-of-range) can represent [A_{D}, ∞).

In one embodiment, for delay reporting (of a CLI reporting described in an example of embodiments herein), one or multiple delay values for each of Nₜᵣₚ (or N≤Nₜᵣₚ) CSI-RS resource or each of Nₜᵣₚ−1 (or N−1) CSI-RS resources are reported as a part of CLI reporting.

In one embodiment, one delay value for CSI-RS resource r is quantized using at least one of the schemes described in one or more embodiments herein.
In one example, one delay value for each of Nₜᵣₚ (or N≤Nₜᵣₚ) CSI-RS resources is quantized and indicated by a (separate) per-TRP (i.e., per-CSI-RS resource) indicator.
In one example, one delay value for each of Nₜᵣₚ−1 (or N−1) CSI-RS resources is quantized and indicated by a (separate) per-TRP (i.e., per-CSI-RS resource) indicator.
In one example, one delay value for each of Nₜᵣₚ (or N≤Nₜᵣₚ) CSI-RS resources is quantized and the Nₜᵣₚ delay values are indicated by a joint indicator.
In one example, one delay value for each of Nₜᵣₚ−1 (or N−1) CSI-RS resources is quantized and the Nₜᵣₚ−1 delay values are indicated by a joint indicator.

In one embodiment, each of two delay values (e.g., first delay tap and last delay tap) for CSI-RS resource r is quantized using at least one of the schemes described in one or more embodiments herein.
In one example, each of two delay values for each of Nₜᵣₚ (or N≤Nₜᵣₚ) CSI-RS resources is quantized and indicated via a (separate) per-TRP (i.e., per-CSI-RS resource) indicator.
In one example, each of two delay values for each of Nₜᵣₚ−1 (or N−1) CSI-RS resources is quantized and indicated via a (separate) per-TRP (i.e., per-CSI-RS resource) indicator.
In one example, each of two delay values for each of Nₜᵣₚ (or N≤Nₜᵣₚ) CSI-RS resources is quantized and the 2Nₜᵣₚ delay values are indicated via a joint indicator.
In one example, each of two delay values for each of Nₜᵣₚ−1 (or N−1) CSI-RS resources is quantized and the 2Nₜᵣₚ−1 delay values are indicated via a joint indicator.

In one example, for the two delay values, D₁ and D₂ (where D₁<D₂), for CSI-RS resource r, alphabet sets [symbol] ₁ and [symbol] ₂ for the two delay values are the same, i.e., D₁ and D₂ are quantized using a same alphabet set, where the alphabet set is one of the examples described in one or more embodiments herein.

In one example, for the two delay values, D₁ and D₂ (where D₁<D₂), for CSI-RS resource r, alphabet sets [symbol] ₁ and [symbol] ₂ for the two delay values can be different, i.e., D₁ and D₂ are quantized using different alphabet sets [symbol] ₁ and [symbol] ₂, respectively, where each of the alphabet sets is one of the examples described in one or more embodiments herein.

In one example, the number of bits B for alphabet sets [symbol] ₁ and [symbol] ₂ can be the same, but the alphabet sets [symbol] ₁ and [symbol] ₂ can be different.

In one example, the number of bits B for alphabet sets [symbol] ₁ and [symbol] ₂ can be different, where B₁ and B₂ are the numbers of bits for alphabet sets [symbol] ₁ and [symbol] ₂, respectively, and B₁>B₂.
In one example, B₁>1 and B₂=1, where D₁ is quantized/indicated using alphabet set with B₁ bits and D₂ is indicated by an 1-bit indicator, whether D₂ (which can correspond to delay spread) is exceeding CP length or not, or exceeding a threshold value or not, or out-of-range or not, or ON or OFF, etc.
In one example, B₁>1 and B₂=1, where D₁ is quantized/indicated using alphabet set with B₁ bits and D₂ is indicated/quantized using alphabet set with 1-bit, e.g., having x₁ and x₂ values.
In one example, B₁>B₂ and B₂>1, where D₁ is quantized/indicated using alphabet set with B₁ bits and D₂ is indicated/quantized using alphabet set with B₂ bits.

In one example, the number of bits B for alphabet sets [symbol] ₁ and [symbol] ₂ can be different, where B₁ and B₂ are the numbers of bits for alphabet sets [symbol] ₁ and [symbol] ₂, respectively, and B₁<B₂.
In one example, B₁=1 and B₂>1, where D₂ is quantized/indicated using alphabet set with B₂ bits and D₁ is indicated by an 1-bit indicator, whether D₁ (which can correspond to delay spread) is exceeding CP length or not, or exceeding a threshold value or not, or out-of-range or not, or ON or OFF, etc.
In one example, B₁=1 and B₂>1, where D₂ is quantized/indicated using alphabet set with B₂ bits and D₁ is indicated/quantized using alphabet set with 1-bit, e.g., having x₁ and x₂ values.
In one example, B₁>1 and B₂>B₁, where D₂ is quantized/indicated using alphabet set with B₂ bits and D₁ is indicated/quantized using alphabet set with B₁ bits.

In examples herein for the two delay values, D₁ and D₂ can be referring to at least one of the following examples.
In one example, D₁ corresponds to a first delay tap/offset and D₂ corresponds to a last delay tap/offset.
In one example, D₁ corresponds to a first delay tap/offset and D₂ corresponds to differential/relative delay value to the first delay tap. In this case, a last delay tap/offset can be expressed as D₁+D₂.
In one example, D₁ corresponds to a first delay tap/offset and D₂ corresponds to delay spread. In this case, a last delay tap/offset can be expressed as D₂-D₁.
In one example, D₂ corresponds to a last delay tap/offset and D₁ corresponds to delay spread. In this case, a first delay tap/offset can be expressed as D₂-D₁.
In one example, D₁ and D₂ are represented in the unit of CP length (i.e., normalized by CP length).
In one example, D₁ and D₂ are represented in absolute time unit (without normalization).
In one example, D₁ and D₂ are represented in the unit of OFDM-symbol/slot time unit (normalized by OFDM symbol/slot duration).

In one embodiment, each of T>2 delay values for CSI-RS resource r is quantized using at least one of the schemes described in one or more embodiments herein.
In one example, each of T delay values for each of Nₜᵣₚ (or N≤Nₜᵣₚ) CSI-RS resources is quantized and indicated via a (separate) per-TRP (i.e., per-CSI-RS resource) indicator.
In one example, each of T delay values for each of Nₜᵣₚ−1 (or N−1) CSI-RS resources is quantized and indicated via a (separate) per-TRP (i.e., per-CSI-RS resource) indicator.
In one example, each of T delay values for each of Nₜᵣₚ (or N≤Nₜᵣₚ) CSI-RS resources is quantized and the 2Nₜᵣₚ delay values are indicated via a joint indicator.
In one example, each of T delay values for each of Nₜᵣₚ−1 (or N−1) CSI-RS resources is quantized and the 2Nₜᵣₚ−1 delay values are indicated via a joint indicator.

In one example, for the T delay values, D₁, D₂, . . . . D_{T} (where D₁<D₂< . . . <D_{T}), for CSI-RS resource r, alphabet sets [symbol] ₁, . . . , [symbol] _{T} for the T delay values are the same, i.e., D₁, D₂, . . . . D_{T} are quantized using a same alphabet set, where the alphabet set is one of the examples described in one or more embodiments herein.

In one example, for the T delay values, D₁, D₂, . . . , D_{T} (where D₁<D₂< . . . <D_{T}), for CSI-RS resource r, alphabet sets [symbol] ₁, . . . , [symbol] _{T} for the T delay values can be different, i.e., D₁, D₂, . . . , D_{T} are quantized using different alphabet sets [symbol] ₁, . . . , [symbol] _{T}, respectively, where each of the alphabet sets is one of the examples described in one or more embodiments herein.

In one example, the number of bits B for alphabet sets [symbol] ₁, . . . , [symbol] _{T} can be the same, but the alphabet sets [symbol] ₁, . . . , [symbol] _{T} can be different.

In one example, the number of bits B for alphabet sets [symbol] ₁, . . . , [symbol] _{T} can be different, where B₁, B₂ . . . . Br are the numbers of bits for alphabet sets [symbol] ₁, . . . , [symbol] _{T} respectively.

In embodiment, the number of bits B for alphabet set A, as described in this disclosure, can be according to at least one of the following examples.

In one example, B (or B₁, B₂) is CSI-RS-resource-common, i.e., a same bit is used across configured CSI-RS resources.

In one example, Br (or B₁,r, B₂,r) is CSI-RS-resource-specific, i.e., a different/independent bit is used across for each configured CSI-RS resource r.

In one example, B depends on the number of CSI-RS resources, i.e., N_{TRP} (or N). For example, B=cN_{TRP}, with a scaling value of c.

In one example, B is fixed or configured by NW, or determined by UE and reported as a part of reporting.

In one embodiment, a UE can be configured with a range value of A_{D} and/or a number of quantization states M (or a number of bits B for quantization states (where M=28)) for CJT delay reporting (or frequency reporting, or phase offset reporting or other joint reporting). Here, the CJT delay reporting can be a delay reporting scheme designed based on an example described in/under one or more embodiments herein. In one example, A_{D} and M (or B) can be designed at least one of the following examples.

In one example, A_{D} can be configurable by NW via RRC signaling (or MAC-CE or DCI).

In one example, M (or B) can be configurable by NW via RRC signaling (or MAC-CE or DCI).

In one example, A_{D} and M (or B) can be separately indicated/configured with separate parameters.

In one example, A_{D} and M (or B) can be jointly indicated/configured with separate parameters.

In one example, the number of supported values of A_{D} is N_{A}. In one example, N_{A}=4. In one example, N_{A}=3. In one example, N_{A}=2. In one example, N_{A}>4. In one example, N_{A}<4.

In one example, the number of supported values of M (or B) is N_{M}. In one example, N_{M}=4. In one example, N_{M}=3. In one example, N_{M}>4. In one example, N_{M}<4.

In one example, the number of supported values of (A_{D}, M) or (A_{D}, B) is N_{J}. In one example, N_{J}=4. In one example, N_{J}=3. In one example, N_{J}>4. In one example, N_{J}<4.

In one example, one of the configurable values of A_{D} corresponds to CP length.

In one example, one of the configurable values of A_{D} corresponds to a value smaller than CP length. In one example, A_{D} corresponds to c×CP, where c<1 e.g., c=0.5 or 0.3 or ⅓.

In one example, one of the configurable values of A_{D} corresponds to a value larger than CP length. In one example, A_{D} corresponds to c×CP, where c>1 e.g., c=1.5 or 1.8 or 2.

In one example, one of the configurable values of M (or B) corresponds to 32 (i.e., B=5 bits).

In one example, one of the configurable values of M (or B) corresponds to a value smaller than 32. In one example, M corresponds to 16 or 8 or 4 or 2.

In one example, one of the configurable values of M (or B) corresponds to a value larger than 32. In one example, M corresponds to 64 or 128 or 256.

In one example, one of the configurable values of (A_{D}, M) (or (A_{D}, B)) corresponds to (CP length, 32).

In one example, one of the configurable values of (A_{D}, M) (or (A_{D}, B)) corresponds to (CP length, X), where X corresponds to a value smaller than 32.

In one example, one of the configurable values of (A_{D}, M) (or (A_{D}, B)) corresponds to (CP length, X), where X corresponds to a value larger than 32.

In one example, one of the configurable values of (A_{D}, M) (or (A_{D}, B)) corresponds to (c×CP length, 16), where c<1, e.g., c=0.5 or 0.3 or ⅓.

In one example, one of the configurable values of (A_{D}, M) (or (A_{D}, B)) corresponds to (c×CP length, X), where c<1, e.g., c=0.5 or 0.3 or ⅓, and X corresponds to a value larger than 16.

In one example, one of the configurable values of (A_{D}, M) (or (A_{D}, B)) corresponds to (c×CP length, X), where c<1, e.g., c=0.5 or 0.3 or ⅓, and X corresponds to a value smaller than 16.

In one example, one of the configurable values of (A_{D}, M) (or (A_{D}, B)) corresponds to (c×CP length, 32), where c>1, e.g., c=1.5 or 1.8 or 2.

In one example, one of the configurable values of (A_{D}, M) (or (A_{D}, B)) corresponds to (c×CP length, X), where c>1, e.g., c=1.5 or 1.8 or 2, and X corresponds to a value larger than 32.

In one example, one of the configurable values of (A_{D}, M) (or (A_{D}, B)) corresponds to (c×CP length, X), where c>1, e.g., c=1.5 or 1.8 or 2, and X corresponds to a value smaller than 32.

In one example, CP length described in this disclosure corresponds to

$$\frac{144}{2056} \cdot \frac{1}{Δ f} or {2}^{z} \times 4.69 \times 1 {0}^{- 6} or \frac{1}{14} . \frac{1}{Δ f} or \frac{1}{4} . \frac{1}{Δ f} ,$$

where Δf is subcarrier spacing (e.g., 15, 30, 60, 120, 240 kHz) and z∈{0, 1, 2, 3, 4}.

In one example, one of the configurable values of A_{D} corresponds to a function of a PMI subband size

$$( e . g . , \frac{x}{Δ {f}_{PMI}} ) ,$$

where the PMI subband size can be calculated based on the number of RBs per PMI subband, e.g.,

$$Δ {f}_{PMI} = {N}_{P R B}^{S B} \times {N}_{sc}^{R B} \times Δ f \times \frac{1}{R} , where {N}_{P R B}^{S B}$$

is the number of RBs per CQI subband,

$${N}_{s c}^{R B}$$

is the number of subcarriers per RB, Δf is subcarrier spacing, and R is the number of precoding matrix (PMIs) per CQI subband.
In one example, each example shown in the herein with replacing the CP by a function of a PMI subband size can be another example.
In one example, the maximum (configurable) value of M (or B) can be determined based on the maximum configurable value N₃ (up to 38) and O₃ (in {1,4}), e.g., N₃O₃ is up to 152. For example, M (or B) does not exceed 256 (or 8 bits).

In one example, one of the configurable values of A_{D} corresponds to a function of reference signal spacing (RS frequency density) in frequency-domain

$$( e . g . , \frac{1}{12 Δ f} , \frac{3}{12 Δ f} )$$

or RB size or subcarrier spacing.
In one example, each example shown in the herein with replacing the CP by a function of reference signal spacing in frequency-domain or RB size or subcarrier spacing can be another example.

$$( e . g . , c \times \frac{1}{12 Δ f} )$$

In one example, A_{D} can be determined based on a value of multiples of a step size, where the step size can be determined by a configured band-width-part (BWP) (in associated CSI-RS resource/resource set measurement), and the multiples can be given by 2^{B}−1 (i.e., M−1).

In one example, a range value of A_{D} can be implicitly configured by NW via RS configuration for measurement and a number of quantization states M (or a number of bits B for quantization states (where M=2^{B})) is only configured.

In one example, a UE is not expected to be configured with A_{D} where the value of A_{D} exceeds a measurable delay value from associated CSI-RS resource/resource set. The measurement delay value can be determined RS density in frequency (spacing between two resource allocation of the RS (e.g., TRS RE density, such as 1 RE/RB/port, 3 RE/RB/port).

In one embodiment, a UE (e.g., the UE 116) is configured (via higher-layer signaling or MAC-CE or DCI) with a report including CSI for Nₜᵣₚ≥1 TRPs or AGs or CSI-RS resources, where the CSI (e.g., RI/PMI/CQI) is calculated/determined based on a calibration-related information (CLI). In one example, the report can be configured via higher-layer parameter CSI-ReportConfig with codebookConfig set to ‘codebookConfig-r18’ (e.g., Rel-18 CJT Type-II CSI). In one example, the report can be configured via higher-layer parameter CSI-ReportConfig with codebookConfig set to a new value (i.e., a quantity relevant to CSI). In one example, the CLI includes information in one of the examples described in this disclosure (e.g., embodiment 0). For example, the information includes quantities of the calibration reporting described in one of the examples in this disclosure (e.g., embodiment 0). In one example, the CLI corresponds to (or includes) the information that the UE reports for a configured calibration reporting described in one of the examples described in this disclosure.

The CSI can be calculated/determined at the UE expecting pre-compensation based on the CLI information (e.g., DO, when ReportQuantity set to ‘cjtc-Dd’). This can facilitate UE-specific DO pre-compensation at the NW (or gNB) since it can avoid UE-specific CSI-RS transmission (which incurs CSI-RS overhead).

In one embodiment, the CLI for determining/calculating the CSI can be either implicitly or explicitly configured.

In one example, the CLI for determining/calculating the CSI includes information that the UE is configured to report for a calibration reporting (e.g., reportQuantity set to ‘cjtc-Dd’ or ‘cjtc-F’, ‘cjtc-Dd-F’). For example, the CSI is calculated/determined expecting (delay/frequency offset) pre-compensation utilizing the information that UE is configured to report (or reported) for the calibration reporting.

In one example, the information is associated with (or corresponds to) a latest calibration reporting. In this case, the CSI can be calculated/determined using the information that the UE reported in the latest calibration reporting from the time that the UE receives CSI-RS resource(s) (or DL RS(s)) for the CSI reporting.

In one example, the information is associated with (or corresponds to) a latest calibration reporting. In this case, the CSI can be calculated/determined using the information that the UE reported in the latest calibration reporting from the time that the UE reports the CSI.

In one example, linking information of the CLI reporting (e.g., CJT-C reporting) and the CSI reporting (e.g., Rel-18 CJT Type-II CSI reporting) can be configured by higher-layer signaling (i.e., RRC). In another example, linking information of the CLI reporting and the CSI reporting (e.g., Rel-18 CJT Type-II CSI reporting) can be configured by MAC-CE or DCI.

In one example, a linked CLI reporting in a report configuration of CSI reporting can be configured via higher-layers signaling (i.e., RRC) or MAC-CE, DCI.

In one embodiment, the UE is configured (or triggered via DCI or MAC-CE or higher-layer signaling) to (jointly) report the CSI and CLI, (i.e., the report includes both the CSI and CLI), where the CSI and CLI are multiplexed and reported in a same slot (i.e., a same PUSCH) (or different slots).

In one example, the CSI is determined/calculated expecting pre-compensation (at the UE) utilizing the CLI that is multiplex with the CSI and reported in a same slot (a same PUSCH).

In one example, the CSI report and the CLI report (e.g., a joint report of them) are triggered by a (same) trigger state via DCI in a aperiodic manner (or a semi-persistent or periodic manner), where the CSI report and CSI report are associated with the trigger state.

In one example, the joint report of the CSI and CLI can be configured (or triggered) only when DO reporting is configured for the CLI reporting (e.g., reportQuantity is set to ‘cjtc-Dd’).

In one example, the joint report of the CSI and CLI can be configured (or triggered) only when frequency offset reporting is configured for the CLI reporting (e.g., reportQuantity is set to ‘cjtc-F’).

In one example, the joint report of the CSI and CLI can be configured (or triggered) only when DO reporting or joint reporting of delay-offset and frequency-offset is configured for the CLI reporting (e.g., reportQuantity is set to ‘cjtc-Dd’ or ‘cjtc-Dd-F’).

In one example, when the DO reporting is configured for the CLI reporting (e.g., reportQuantity is set to ‘cjtc-Dd’ or ‘cjtc-Dd-F’), the CSI part 1 does not include TRP selection indicator (i.e., Nₜᵣₚ-bit bitmap indicator in CSI Part 1 for CJT CSI reporting, cf) Rel-18 CJT CSI), regardless of restrictedCMR-selection set to enabled or not. For example, this is because DO reporting already contains TRP selection information.

In one example, when the frequency offset reporting is configured for the CLI reporting (e.g., reportQuantity is set to ‘cjtc-Dd’ or ‘cjtc-Dd-F’), the CSI part 1 does not include TRP selection indicator (i.e., Nₜᵣₚ-bit bitmap indicator in CSI Part 1 for CJT CSI reporting, cf) Rel-18 CJT CSI), regardless of restrictedCMR-selection set to enabled or not. For example, when ‘invalid’ state is indicated for a TRS set(s) (TRPs) for the CLI reporting, the corresponding TRP(s) or CSI-RS resource(s) can be regarded as not selected TRPs.

In another example, when the joint report of the CSI and CLI is configured, the UE is not expected to be configured with enabling TRP selection (e.g., restrictedCMR-selection) for the CSI reporting.

In another example, when the joint report of the CSI and CLI is configured, the UE follows the configured information on enabling TRP selection (e.g., restrictedCMR-selection) for the CSI reporting.

In one example, when the linking (or association) of CSI (e.g., Rel-18 CJT CSI) and CLI (e.g., Rel-19 coherent joint transmission calibration (CJTC) DO (delay offset) reporting, frequency offset (FO) reporting, DO-FO reporting, or phase offset (PO) reporting) reports is configured with a separate trigger, the UE shall expect the dynamic TRP selection is not enabled (e.g., restrictedCMR-selection being regarded as enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, the UE is not expected to be configured with enabling the dynamic TRP selection (e.g., restrictedCMR-selection being not enabled or not configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, the UE is expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, the UE shall expect the dynamic TRP selection to be enabled (e.g., restrictedCMR-selection being regarded as not enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, the UE is not expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, the UE is expected to be configured with enabling the dynamic TRP selection (e.g., restrictedCMR-selection being not enabled or not configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE shall expect the dynamic TRP selection is not enabled (e.g., restrictedCMR-selection being regarded as enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE is not expected to be configured with enabling the dynamic TRP selection (e.g., restrictedCMR-selection being not enabled or not configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE is expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE shall expect the dynamic TRP selection to be enabled (e.g., restrictedCMR-selection being regarded as not enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE is not expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, the UE is expected to be configured with enabling the dynamic TRP selection (e.g., restrictedCMR-selection being not enabled or not configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE shall expect the dynamic TRP selection to not be enabled (e.g., restrictedCMR-selection being regarded as enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE is not expected to be configured with enabling the dynamic TRP selection (e.g., restrictedCMR-selection being not enabled or not configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE is expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE shall expect the dynamic TRP selection is enabled (e.g., restrictedCMR-selection being regarded as not enabled/configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE is not expected to be configured with enabling no dynamic TRP selection (e.g., restrictedCMR-selection being enabled or configured) for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured (with a separate trigger or a joint trigger), the UE is expected to be configured with enabling the dynamic TRP selection (e.g., restrictedCMR-selection being not enabled or not configured) for the CSI reporting.

In one example, the joint report of the CSI and CLI is conveyed in a single CSI report.

In one example, the joint report of the CSI and CLI is conveyed in a separate CSI report, respectively.

In one example, the CLI for determining/calculating the CSI can be configured by NW, and the UE calculates/determines the CSI based on the configured CLI. In one example, DO and/or frequency offset values for each of the TRPs (or AGs or CSI-RS resources) are explicitly configured to the UE for the CSI report (e.g., Rel-18 CJT CSI reporting).

In one example, a set of configurable DO values is the same as a set of possible reported DO values from calibration reporting (e.g., when reportQuantity set to ‘cjtc-Dd’ or ‘cjtc-Dd-F’).

In one example, a set of configurable DO values is different from a set of possible reported DO values from calibration reporting (e.g., when reportQuantity set to ‘cjtc-Dd’ or ‘cjtc-Dd-F’)

In one example, a set of configurable frequency offset values is the same as a set of possible reported frequency offset values from calibration reporting (i.e., when reportQuantity set to ‘cjtc-F’ or ‘cjtc-Dd-F’).

In one example, a set of configurable frequency offset values is different from a set of possible reported frequency offset values from calibration reporting (i.e., when reportQuantity set to ‘cjtc-F’ or ‘cjtc-Dd-F’).

In one embodiment, Nₜᵣₚ CSI-RS resources for the CSI reporting and Nₜᵣₚ CSI-RS resource sets for the CLI reporting follow a pre-defined mapping rule or an implicitly configured rule, or an explicitly configured rule.

In one example, the lowest index of CSI-RS resource configured for the CSI reporting corresponds to the lowest index of CSI-RS resource set configured for the CLI reporting, and the second lowest index of CSI-RS resource configured for the CSI reporting corresponds to the second lowest index of CSI-RS resource set configured for the CLI reporting, and so on.

In one embodiment, the report includes TRP (CSI-RS resource) selection indicator via Nₜᵣₚ-bit (or N(≤Nₜᵣₚ)-bit) bitmap to indicate the TRP or CSI-RS resource for which the UE is not able to perform pre-compensation utilizing the CLI.

In one example, the report includes the indicator regardless of restrictedCMR-Selection set to enabled or not.

In one embodiment, there is restriction for configuring the CSI reporting. In one example, the UE is not expected to be configured with the CSI reporting, associated with the CLI reporting, where a dynamic range of DO is configured to a certain value. For example, the dynamic range of A_{D}<x CP can be configurable. For example, x=1. For example, the UE is not expected to be configured with dynamic range of A_{D}=1 CP or dynamic range of A_{D}>1 CP.

In one embodiment, a CSI reporting based on a CLI reporting can be configured according to UE capability.

In one example, the capability of a joint triggering to trigger CSI report and CLI report (e.g., ‘cjtc-Dd’, ‘cjtc-F’, ‘cjtc-Dd-F’, or others) multiplexed in a same PUSCH (or in a same PUSCH slot) is a separate UE Group feature based on a UE capability. In one example, the capability of a joint triggering is an optional feature of UE capability. In another example, the capability of a joint triggering is a basic feature of UE capability.

In one example, the capability of linking CSI report (e.g., according to one or more embodiments described herein) with CLI report (e.g., ‘cjtc-Dd’, ‘cjtc-F’, ‘cjtc-Dd-F’, or others) is a separate UE Group feature based on a UE capability. In one example, the capability of linking CSI report is an optional feature of UE capability. In another example, the capability of linking CSI report is a basic feature of UE capability.

In one example, the capability of CSI report with configuring explicit delay/frequency offset values (e.g., an example of one or more embodiments described herein) is a separate UE Group feature based on a UE capability. In one example, the capability of CSI report with configuring explicit delay/frequency offset values is an optional feature of UE capability. In another example, the capability of CSI report with configuring explicit delay/frequency offset values is a basic feature of UE capability.

In one embodiment, time-domain behavior of a CSI-RS resource setting or a CSI report setting for a CSI reporting based on a CLI reporting can be according to at least one of the following examples.

In one example, aperiodic (AP) CSI-RS can (only) be configured in the CSI-RS resource setting for measurement.

In one example, AP/semi-persistent (SP) CSI-RS can (only) be configured in the CSI-RS resource setting for measurement.

In one example, AP/SP/periodic (P) CSI-RS can (only) be configured in the CSI-RS resource setting for measurement.

In one example, SP/P CSI-RS can (only) be configured in the CSI-RS resource setting for measurement.

In one example, AP CSI reporting can (only) be triggered or configured to perform for the CSI reporting.

In one example, AP/SP CSI reporting can (only) be triggered or configured to perform for the CSI reporting.

In one example, AP/SP/P CSI reporting can (only) be triggered or configured to perform for the CSI reporting.

In one example, SP/P CSI reporting can (only) be triggered or configured to perform for the CSI reporting.

In one example, when the linking (or association) of CSI (e.g., Rel-18 CJT CSI) and

CLI (e.g., Rel-19 CJTC DO reporting, FO reporting, DO-FO reporting, or PO reporting) reports is configured with a separate trigger, only AP-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, AP/SP-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, AP/P-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, SP/P-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a separate trigger, AP/SP/P-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, only AP-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, aperiodic (AP)/SP-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, AP/periodic (P)-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, SP/P-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured with a joint trigger, AP/SP/P-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured, only AP-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured, AP/SP-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured, AP/P-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured, SP/P-CSI-RS can be configured as the CMR for the CSI reporting.

In one example, when the linking (or association) of CSI (e.g., Rel-18 CJT CSI) and CLI (e.g., Rel-19 CJTC DO reporting, FO reporting, DO-FO reporting, or PO reporting) reports is configured, AP/SP/P-CSI-RS can be configured as the CMR for the CSI reporting.

In one embodiment, an indicator(s) is included in a CSI report (e.g., one example described in embodiments herein), where the indicator is associated with a CLI report (one example described in this disclosure).

In one example, an indicator is a 1-bit (or X-bit, where X>1) indicator to indicate whether the CSI is calculated based on the associated CLI report or not. For example, the indicator has ‘0’ indicating the CSI is calculated without using the associated CLI report, and ‘1’ indicating the CSI is calculated based on the associated CLI report, or vice-versa.

In one example, an indicator is a 1-bit (or X-bit, where X>1) indicator to indicate whether the CSI cannot be (or is difficult to be, or is not) calculated based on the associated CLI report or not. For example, when there are DO values exceeding CP length, it is difficult to obtain the accurate CSI associated with the CLI report. In this case, the indicator can indicate the situation.

In one example, an indicator or a joint indicator (>1 bit) of indicating the herein in the examples can be included in the CSI report. For example, the indicator has at least three states (e.g., at least 2 bit is needed) that state 1 indicates the CSI is calculated based on the associated CLI report, state 2 indicates the CSI is calculated without using the associated CLI report, and state 3 indicates the CSI can't be calculated using the associated CLI report.

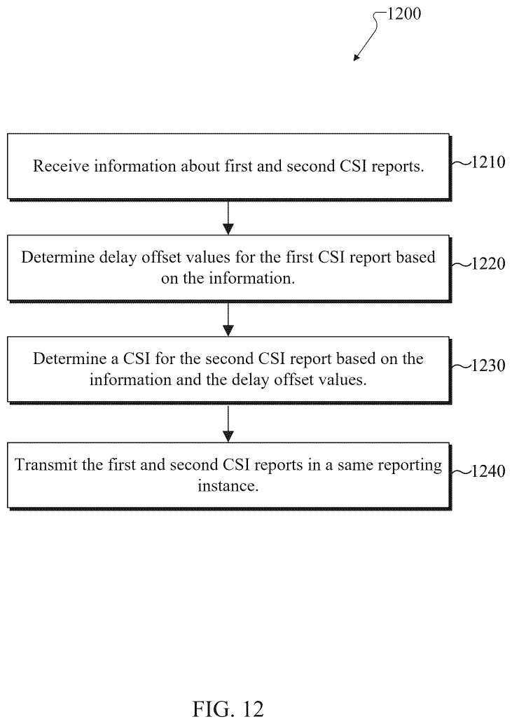

FIG. 12 illustrates an example method 1200 performed by a UE in a wireless communication system according to embodiments of the present disclosure. The method 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1200 is for illustration only and other embodiments can be used without departing from the scope of the present disclosure.

The method 1200 begins with the UE receiving information about first and second CSI reports (1210). For example, in 1210, the information indicates for the first CSI report, N_{TRP} CSI-RS resource sets, N_{TRP}>1 and a report quantity, which corresponds to DO reporting and, for the second CSI report, N_{TRP} CSI-RS resources and a codebook type. The codebook type is set to ‘typeII-CJT-r18’. The first and second CSI reports are configured to be linked via a higher-layer parameter.

In various embodiments, the first and second CSI reports are associated with an aperiodic trigger state and the aperiodic trigger state is indicated via DCI. In various embodiments, the N_{TRP} CSI-RS resources are configured to aperiodic CSI-RS. In various embodiments, the CSI-RS resource sets correspond to the CSI-RS resources by a fixed correspondence between resource set indexes and resource indexes, respectively, in sequential order of configuration. In various embodiments, the higher-layer parameter is subject to a UE capability and the UE capability is an optional UE feature.

The UE then determines DO values for the first CSI report based on the information (1220). The UE then determines a CSI for the second CSI report based on the information and the DO values (1230). For example, in 1230, the CSI is determined by compensating for the delay offset values.

The UE then transmits the first and second CSI reports in a same reporting instance (1240). For example, in 1240, the first and second CSI reports include the delay offset values and the CSI, respectively. In various embodiments, a N_{TRP}-bit bitmap indicator is not included in the second CSI report, even when a higher-layer parameter restrictedCMR-selection is not configured. In various embodiments, the UE is not expected to be configured with a higher-layer parameter restrictedCMR-selection.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about first and second channel state information (CSI) reports, the information indicating:
for the first CSI report, (i) N_{TRP} CSI reference signal (CSI-RS) resource sets, N_{TRP}>1 and (ii) a report quantity, wherein the report quantity corresponds to delay offset (DO) reporting, and
for the second CSI report, (iii) N_{TRP} CSI-RS resources and (iv) a codebook type, wherein the codebook type is set to ‘typeII-CJT-r18’, wherein the first and second CSI reports are configured to be linked via a higher-layer parameter; and
a processor operably coupled to the transceiver, the processor configured to:
determine, based on the information, DO values for the first CSI report; and
determine, based on the information and the DO values, a CSI for the second CSI report, wherein the CSI is determined by compensating for the DO values,
wherein the transceiver is further configured to transmit the first and second CSI reports in a same reporting instance, wherein the first and second CSI reports include the DO values and the CSI, respectively.

2. The UE of claim 1, wherein:
the first and second CSI reports are associated with an aperiodic trigger state, and
the aperiodic trigger state is indicated via downlink control information (DCI).

3. The UE of claim 1, wherein the N_{TRP} CSI-RS resources are configured to aperiodic CSI-RS.

4. The UE of claim 1, wherein the CSI-RS resource sets correspond to the CSI-RS resources by a fixed correspondence between resource set indexes and resource indexes, respectively, in sequential order of configuration.

5. The UE of claim 1, wherein:
the higher-layer parameter is subject to a UE capability, and
the UE capability is an optional UE feature.

6. The UE of claim 1, wherein a N_{TRP}-bit bitmap indicator is not included in the second CSI report, even when a higher-layer parameter restrictedCMR-selection is not configured.

7. The UE of claim 1, wherein the UE is not expected to be configured with a higher-layer parameter restrictedCMR-selection.

8. A base station (BS) comprising:
a processor; and
a transceiver operably coupled to the processor, the transceiver configured to:
transmit, to a user equipment (UE), information about first and second channel state information (CSI) reports, the information indicating:
for the first CSI report, (i) N_{TRP} CSI reference signal (CSI-RS) resource sets, N_{TRP}>1 and (ii) a report quantity, wherein the report quantity corresponds to delay offset (DO) reporting, and
for the second CSI report, (iii) N_{TRP} CSI-RS resources and (iv) a codebook type, wherein the codebook type is set to ‘typeII-CJT-r18’, wherein the first and second CSI reports are configured to be linked via a higher-layer parameter; and
receive, from the UE, the first and second CSI reports in a same reporting instance,
wherein the first and second CSI reports include DO values and a CSI, respectively,
wherein the DO values for the first CSI report are based on the information,
wherein the CSI for the second CSI report are based on the information and the DO values, and
wherein the CSI compensates for the DO values.

9. The BS of claim 8, wherein:
the first and second CSI reports are associated with an aperiodic trigger state, and
the aperiodic trigger state is indicated via downlink control information (DCI).

10. The BS of claim 8, wherein the N_{TRP} CSI-RS resources are configured to aperiodic CSI-RS.

11. The BS of claim 8, wherein the CSI-RS resource sets correspond to the CSI-RS resources by a fixed correspondence between resource set indexes and resource indexes, respectively, in sequential order of configuration.

12. The BS of claim 8, wherein:
the higher-layer parameter is subject to a UE capability, and
the UE capability is an optional UE feature.

13. The BS of claim 8, wherein a N_{TRP}-bit bitmap indicator is not included in the second CSI report, even when a higher-layer parameter restrictedCMR-selection is not configured.

14. The BS of claim 8, wherein the UE is not expected to be configured with a higher-layer parameter restrictedCMR-selection.

15. A method performed by a user equipment (UE), the method comprising:
receiving information about first and second channel state information (CSI) reports, the information indicating:
for the first CSI report, (i) N_{TRP} CSI reference signal (CSI-RS) resource sets, N_{TRP}>1 and (ii) a report quantity, wherein the report quantity corresponds to delay offset (DO) reporting, and
for the second CSI report, (iii) N_{TRP} CSI-RS resources and (iv) a codebook type, wherein the codebook type is set to ‘typeII-CJT-r18’, wherein the first and second CSI reports are configured to be linked via a higher-layer parameter;
determining, based on the information, DO values for the first CSI report;
determining, based on the information and the DO values, a CSI for the second CSI report, wherein the CSI is determined by compensating for the DO values; and
transmitting the first and second CSI reports in a same reporting instance, wherein the first and second CSI reports include the DO values and the CSI, respectively.

16. The method of claim 15, wherein:
the first and second CSI reports are associated with an aperiodic trigger state, and
the aperiodic trigger state is indicated via downlink control information (DCI).

17. The method of claim 15, wherein the N_{TRP} CSI-RS resources are configured to aperiodic CSI-RS.

18. The method of claim 15, wherein the CSI-RS resource sets correspond to the CSI-RS resources by a fixed correspondence between resource set indexes and resource indexes, respectively, in sequential order of configuration.

19. The method of claim 15, wherein:
the higher-layer parameter is subject to a UE capability, and
the UE capability is an optional UE feature.

20. The method of claim 15, wherein a N_{TRP}-bit bitmap indicator is not included in the second CSI report, even when a higher-layer parameter restrictedCMR-selection is not configured.
